(19) United States
(12) Patent Application Publication
(10) Pub. No.: US 2026/0303007 A1
(43) Pub. Date: Oct. 1, 2026

(54) MODULE CLAMP APPARATUS AND SYSTEMS THEREOF

(71) Applicant: Unirac, Inc., Albuquerque, NM (US)

(72) Inventors: Elmer Ramos, Albuquerque, NM (US); Tarun Kumar Polanky, Hyderabad (IN)

(21) Appl. No.: 19/630,200

(22) Filed: Mar. 26, 2026

Related U.S. Application Data
(60) Provisional application No. 63/780,037, filed on Mar. 28, 2025.
(60) Provisional application No. 63/899,887, filed on Oct. 15, 2025.

(51) Int. Cl. H02S 20/30

(52) U.S. Cl. CPC H02S 20/30

(57) ABSTRACT

A clamp assembly includes a bonding clamp, a fastener, and a clamp base. The bonding clamp includes a wall extending in a first direction to engage a first solar panel module, a first ledge extends in a second direction transverse to the first direction at a first end of the lateral edge support configured to engage an upper surface of the first solar panel module, and a second ledge extends in a third direction opposite the second direction at the first end of the lateral edge support configured to engage the upper surface of a second solar panel module. The fastener has a first end opposite a second end, the first end configured to interface with the second ledge. The clamp base being attached to the fastener, and including a frame, a nut is configured to engage with the fastener, and a grounding clip partially surrounds the nut.

### CROSS-REFERENCED TO RELATED APPLICATIONS

This application claims priority to U.S. Provisional Patent Application No. 63/780,037, filed Mar. 28, 2025, titled “MODULE CLAMP APPARATUS AND SYSTEMS THEREOF” and U.S. Provisional Patent Application No. 63/899,887, filed Oct. 15, 2025, titled “MODULE CLAMP APPARATUS AND SYSTEMS THEREOF,” both of which are incorporated herein by reference in their entirety.

### BACKGROUND

As the solar energy industry continues to grow, the equipment to mount solar photovoltaic (PV) modules on different types of structures and/or locations continues to adapt and improve as well. Conventional solar PV modules mounting assemblies are frequently designed to be installed and adjusted with multiple steps. As such, conventional mounting assemblies frequently cannot be adjusted and electrically grounded with a single step. Despite the numerous existing systems for mounting solar panels modules, there is room for improvement.

### BRIEF DESCRIPTION OF THE DRAWINGS

FIG. 1 illustrates a side-front view of a module clamp, according to an embodiment of this disclosure.

FIG. 2 illustrates a front-side view of the module clamp of FIG. 1, according to an embodiment of this disclosure.

FIG. 3 illustrates a bottom-side view of the module clamp of FIG. 1, according to an embodiment of this disclosure.

FIG. 4A illustrates a front-side isometric view of a module clamp installed in a mounting rail, according to an embodiment of this disclosure.

FIG. 4B illustrates a front-side view of the module clamp of FIG. 4A, according to an embodiment of this disclosure.

FIG. 5 illustrates a side view of the module clamp of FIG. 4A, according to an embodiment of this disclosure.

FIG. 6 illustrates a partial cross-sectional of a side view of the module clamp of FIG. 4A, according to an embodiment of this disclosure.

FIG. 7 illustrates a bottom-front-side view of the module clamp of FIG. 4A, according to an embodiment of this disclosure.

FIG. 8 illustrates a bottom-front closeup view of a portion of the module clamp of FIG. 4A, according to an embodiment of this disclosure.

FIG. 9 illustrates an exploded front-side view of a module clamp, according to an embodiment of this disclosure.

FIG. 10 illustrates a side profile view of the module clamp of FIG. 9, according to an embodiment of this disclosure.

FIG. 11 illustrates a side profile view of the module clamp of FIG. 9, according to an embodiment of this disclosure.

FIG. 12 illustrates an exploded front-side view of a module clamp, according to an embodiment of this disclosure.

FIG. 13 illustrates a side profile view of an assembled module clamp of FIG. 12, according to an embodiment of this disclosure.

FIG. 14 illustrates another side profile view, rotated from FIG. 13, of the module clamp of FIG. 12, according to an embodiment of this disclosure.

FIG. 15 illustrates an isometric view a rail nut assembly, according to an embodiment of this disclosure.

FIG. 16 illustrates an isometric view of a bonding clamp, according to an embodiment of this disclosure.

FIG. 17 illustrates a front view of a bonding clamp, according to an embodiment of this disclosure.

FIG. 18 illustrates an isometric view of a portion of the module clamp of FIG. 12, according to an embodiment of this disclosure.

FIG. 19 illustrates a side view of a portion of the module clamp of FIG. 12, according to an embodiment of this disclosure.

FIG. 20 illustrates a side-front view of a module clamp, according to an embodiment of this disclosure.

FIG. 21 illustrates a side view of a retainer clip, according to an embodiment of this disclosure.

FIG. 22 illustrates an isometric view of a retainer clip, according to an embodiment of this disclosure.

FIG. 23 illustrates a side-front view of a portion of a retainer clip, according to an embodiment of this disclosure.

FIG. 24 illustrates an isometric view of a rail nut, according to an embodiment of this disclosure.

FIG. 25 illustrates a side profile view of a rail nut, according to an embodiment of this disclosure.

FIG. 26 illustrates a bottom-side view of a grounding tab, according to an embodiment of this disclosure.

FIG. 27 illustrates stages (A-C) of installation of a module clamp into a mounting rail, according to an embodiment of this disclosure.

### DETAILED DESCRIPTION

### Overview

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

This disclosure is directed to a module clamp apparatus and system used to mount solar panel modules and other PV components to a mounting rail. More specifically, compared with conventional module clamps and systems, the embodiments of a module clamp apparatus as described herein may have advantages including improved electrical bonding methods.

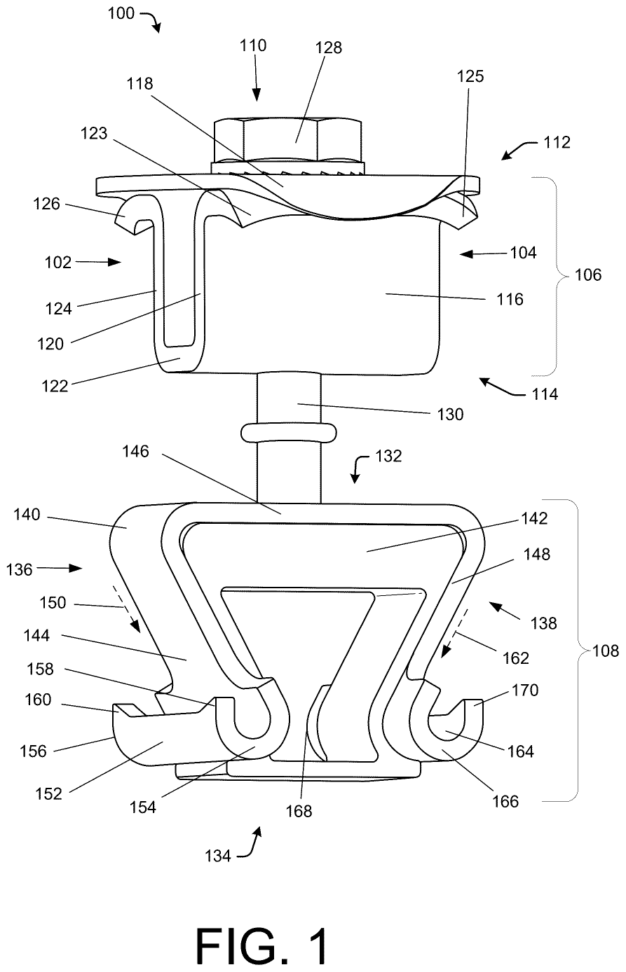

Turning to the drawings, FIG. 1 illustrates a side-front view of a module clamp 100 having a side 102 (e.g., first side, etc.) and a side 104 (e.g., second side, etc.). In an embodiment, the module clamp 100 may have an upper portion 106 (e.g., bonding clamp, clamping portion, etc.), a lower portion 108 (e.g., rail nut, etc.), and a fastener 110.

In an embodiment, the upper portion 106 may have a top end 112 and a bottom end 114 and include a clamping body 116 and a washer 118. The clamping body 116 may include a wall 120 (e.g., first wall, etc.), a base 122, and a wall 124 (e.g., second wall, etc.). The first wall 120 may include a point 123 (e.g., first point, front point, etc.) at the top end 112 of the side 102 of the first wall 120, where the top end 112 flares outward. The first wall 120 may include a point 125 (e.g., second point, rear point, etc.) at the top end 112 of the side 104 of the first wall 120, opposite the point 123. In an embodiment, the point 123 and point 125 may be configured to scratch the outside surface of a solar panel module in order to facilitate electrical bonding when the clamp is installed on the solar panel module.

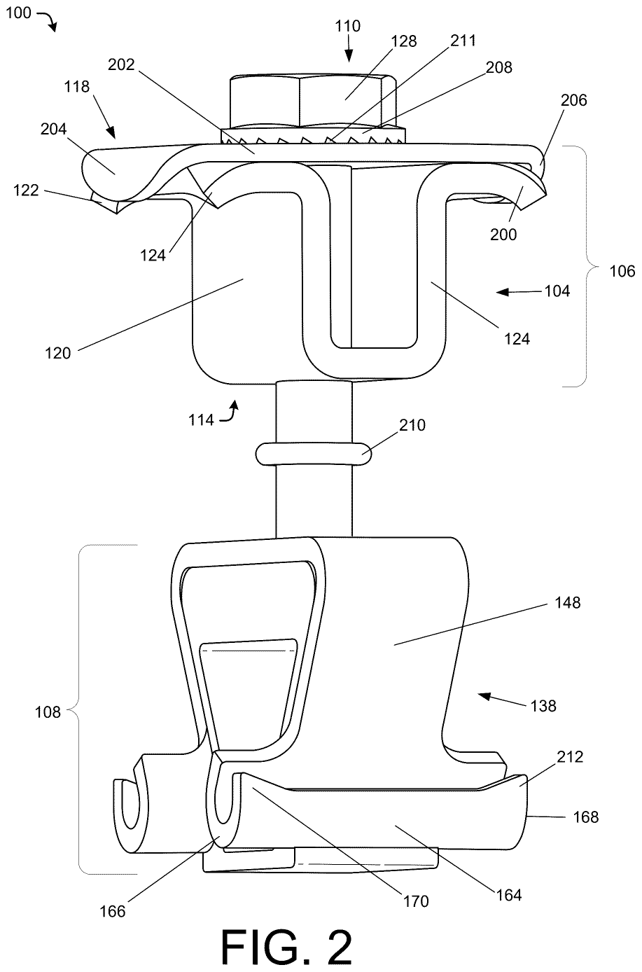

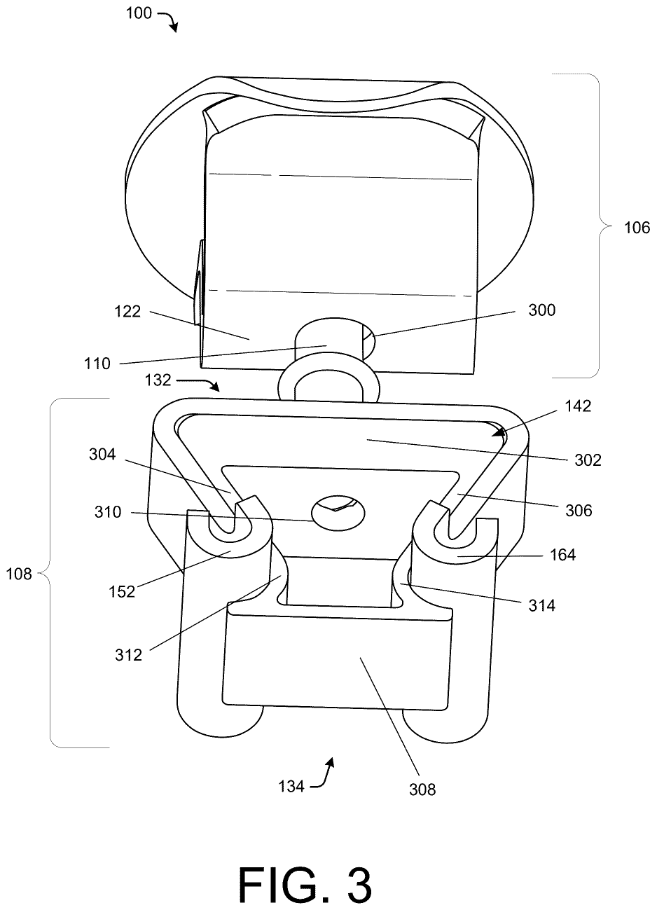

In an embodiment, the second wall 124 may be mirror-symmetric of the first wall 120. Accordingly, the second wall 124 may include a point 126 (e.g., third point, front point, etc.) at the top end 112 of the side 102 of the second wall 124. The second wall 124 may also include a point 200 (e.g., second point, rear point, etc.) (not shown in FIG. 1, see FIG. 2) at the top end 112 of the side 104 of the second wall 124, opposite the point 126. In an embodiment, the base 122 may extend from the bottom end 114 of the first wall 120 to the bottom end 114 of the second wall 124. The base 122 is integral with the first wall 120 and the second wall 124, such that the first wall 120 and the second wall 124 form a U-shape with the base 122. Additionally, the base 122 may include an aperture 300 (not shown in FIG. 1, see FIG. 3) sized to accommodate the fastener 110 therethrough.

In an embodiment, the fastener 110 (e.g., hex-head bolt, Allen bolt, Torx-tipped bolt, flanged-head, non-flanged head, shouldered, etc.) may include a head 128 and a shank 130. It is understood that the configuration of fastener 110 will affect the orientation and appearance of the head 128 and the shank 130. For example, in an embodiment, the fastener 110 may be a flanged hex-head shouldered bolt. Accordingly, the head 128 may include a hexagonal portion and a flanged portion, while the shank 130 may include a non-threaded shoulder portion and a threaded end portion.

In an embodiment, the lower portion 108 may have a top end 132 (e.g., first end upper end, etc.) and a bottom end 134 (e.g., second end, lower end, etc.). The lower portion 108 may have a side 136 (e.g., first side, etc.) and a side 138 (e.g., second side, etc.) opposite the side 136. The lower portion 108 may include a frame 140 and a base 142. The frame 140 may include a wall 144 (e.g., first wall, etc.), a bridge 146, and a wall 148 (e.g., second wall, etc.).

In an embodiment, the wall 144 may extend from the top end 132 of the side 136 of the frame 140 toward the bottom end 134 of the side 138 of the frame 140 in a direction 150. The bottom end 134 of the wall 144 may include a curled portion 152 (e.g., first curled portion, return hooked edge, etc.) that curls away from wall 148. In an embodiment, the curled portion 152 may have an end 154 (e.g., first end, front end, etc.) and an end 156 (e.g., second end, rear end, etc.) opposite the end 154. In an embodiment, the curled portion 152 may include a point 158 at the end 154 of the curled portion 152. In an embodiment, the curled portion 152 may include a point 160 at the end 156 of the curled portion 152.

In an embodiment, the wall 148 may extend from the top end 132 of the side 138 of the frame toward the bottom end 134 of the side 136 of the frame 140 in a direction 162. The bottom end 134 of the wall 148 may include a curled portion 164 (e.g., second curled portion, return hooked edge, etc.) that curls away from wall 144. In an embodiment, the curled portion 164 may have an end 166 (e.g., first end, front end, etc.) and an end 168 (e.g., second end, rear end, etc.) opposite the end 166. In an embodiment, the curled portion 164 may include a point 170 at the end 166 of the curled portion 164.

The bridge 146 may extend from the top end 132 of the side 136 of the wall 144 to the top end 132 of the side 138 of the wall 148. The bridge may include an aperture 300 (not shown in FIG. 1, see FIG. 3) extending through the bridge 146.

FIG. 2 illustrates a front-side view of the module clamp 100 of FIG. 1, In an embodiment, the washer 118 may include a curved edge 202 (e.g., first curved edge, etc.), a folded edge 204 (e.g., first folded edge, etc.) and a folded edge 206 (e.g., second folded edge, etc.) opposite the folded edge 204. The curved edge 202 may extend from the folded edge 204 to the folded edge 206. In an embodiment, the folded edge 204 may curve in a direction toward the lower portion 108. The folded edge 204 may extend between the point 123 and the point 125. In an embodiment, the folded edge 206 may be mirror-symmetric of the folded edge 204.

In an embodiment, the head 128 of the fastener 110 may include a flanged portion 208 and an O-ring 210. The flanged portion 208 may include a serrated surface 211 oriented to contact the washer 118. In an embodiment, the O-ring 210 may be rubber, nylon, or any other suitable material. The curled portion 164 may include a point 212 at the end 168 of the curled portion 164.

FIG. 3 illustrates a bottom-side looking, perspective-view of the module clamp 100 of FIG. 1. In an embodiment, the base 122 of the upper portion 106 may include an aperture 300. The aperture 300 may be sized to accommodate the fastener 110 to pass therethrough.

In an embodiment the base 142 may include an upper portion 302, a wall 304 (e.g., first wall, etc.), a wall 306 (e.g., second wall, etc.), and a lower portion 308. The upper portion 302 may include an aperture 310. In an embodiment the aperture 310 may be threaded and may be sized to engage with the fastener 110.

In an embodiment, the wall 304 of the base 142 may extend from the upper portion 302 to the lower portion 308 of the base 142. The wall 304 may include a curved portion 312 (e.g., first curved portion, etc.) at the bottom end 134 of the base 142. The curved portion 312 may be configured to receive the curled portion 152.

In an embodiment, the wall 306 of the base 142 may extend from the upper portion 302 to the lower portion 308 of the base 142. The wall 306 may include a curved portion 314 (e.g., second curved portion, etc.) at the bottom end 134 of the base 142. The curved portion 314 may be configured to receive the curled portion 164.

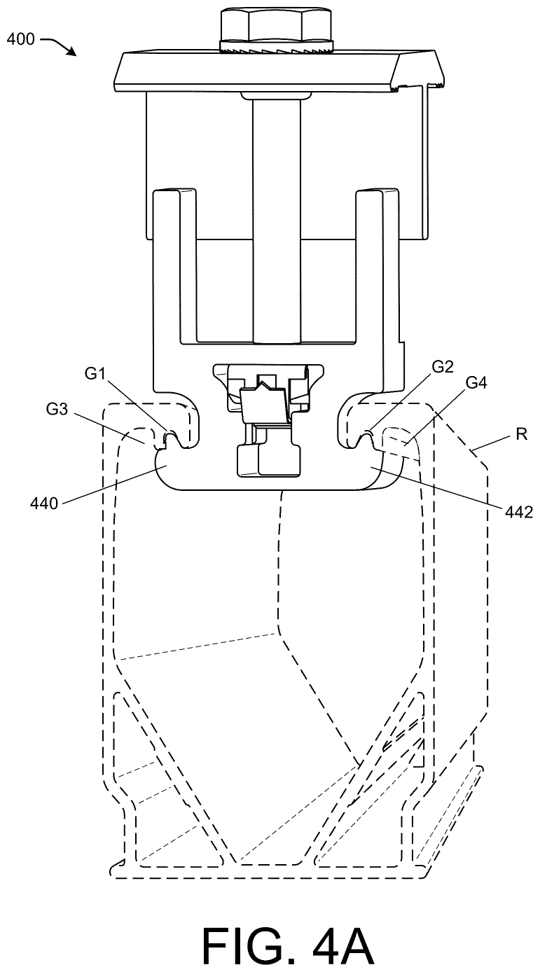

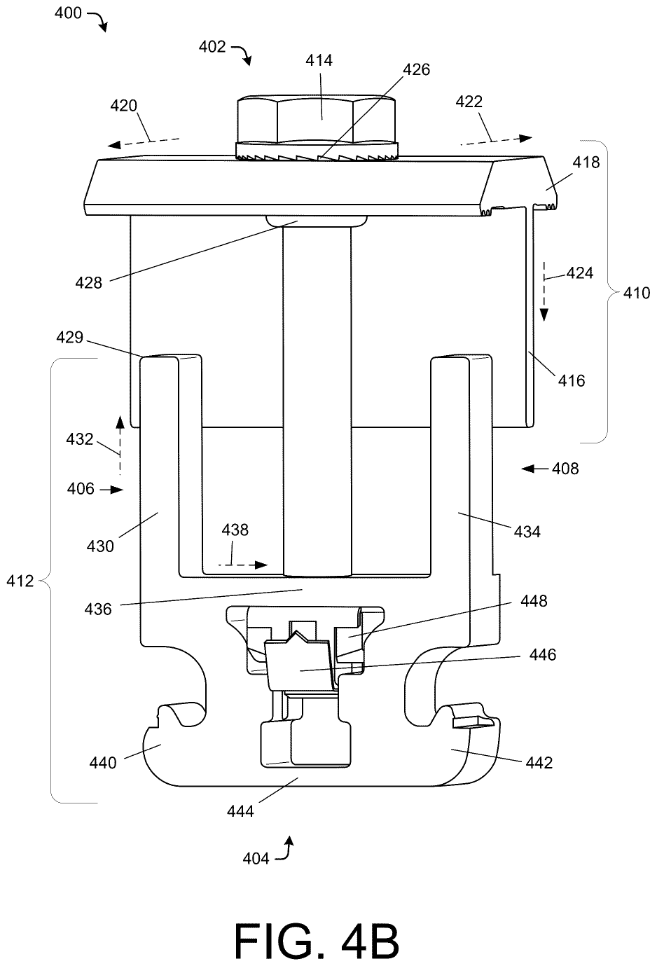

FIG. 4A illustrates a front-side isometric view of a module clamp 400 installed in a mounting rail R. The mounting rail R is configured to extend a running length of a line of consecutive rails by connecting, for example, a first segment of mounting rail R to a second segment of mounting rail R (not shown).

In an embodiment, the mounting rail R may include a first inner groove G1, first outer groove G3, a second inner groove G2, and second outer groove G4. In an embodiment, first inner groove G1 may be configured to receive rail portion 440 and second inner groove G2 may be configured to receive rail portion 442. In an embodiment, first outer groove G3 and second outer groove G4 may be configured to receive a splice rail (not shown).

FIG. 4B illustrates a front-side view of the module clamp 400 of FIG. 4A. In an embodiment, the module clamp 400 may have a top end 402, a bottom end 404, a front side 406, and a rear side 408. In an embodiment, the module clamp 400 may include an upper portion 410 (e.g., bonding clamp) attached to a lower portion 412 (e.g., clamp base) via a fastener 414.

In an embodiment, the upper portion 410 may include a ledge 416 (e.g., lateral edge support, etc.) and a wall 418 (e.g., clamp ledge, etc.). In an embodiment, the wall 418 may extend in a direction 420 and a direction 422 parallel to direction 420. In an embodiment, the ledge 416 may be configured to planarly engage with a lateral edge of a solar panel module. In an embodiment, the ledge 416 may extend from the top end 402 of the upper portion 410 to the bottom end 404 of the upper portion 410 in a direction 424 that is transverse to direction 420. In an embodiment, the wall 418 may be configured to clamp against the top surface of a solar panel module.

In an embodiment, the fastener 414 may be a hex-head bolt, Allen bolt, Torx-tipped bolt, flanged-head, non-flanged head, shouldered, or any other suitable threaded fastener. The fastener 414 may include a serrated flange 426. In an embodiment, the serrated flange may interface with a surface of the wall 418 such that the serrated flange may scratch, mar, or otherwise compromise the coating of the wall 418 (e.g., scratch an anodized coating, remove a paint layer, etc.) to improve grounding (e.g. electrical grounding, electrical bonding, etc.). The fastener 414 may include an O-ring 428. The O-ring 428 may be rubber, nylon, or any other suitable material. In an embodiment, the O-ring may be installed on the fastener 414 between the upper portion 410 and the lower portion 412.

In an embodiment, the lower portion 412 may include a frame 429, a grounding clip 446, and a nut 448. Although the nut 448 is depicted in FIG. 4B as a square nut (e.g., the nut has a square-shaped perimeter), the nut 448 may be octagonal, or any other shape, as desired. In an embodiment, the grounding clip 446 may be configured to partially surround (e.g., envelop, capture, etc.) the nut 448. In an embodiment, the frame 429 may include an arm 430 (e.g., first arm, first side arm, etc.) extending in a direction 432, an arm 434 (e.g., second arm, second side arm, etc.) extending in the direction 432, a bridge section 436 extending from the arm 430 to the arm 434 in a direction 438, a rail portion 440 (e.g., first rail portion, etc.), a rail portion 442 (e.g., second rail portion, etc.), and a base portion 444. In an embodiment, the bridge section 436 of the frame 429 may include an aperture 437 configured to accommodate the fastener 414.

In an embodiment, the fastener 414 may extend through the top end 402 of the upper portion 410, through the bridge section 436 of the lower portion 412, through the grounding clip 446, and through the nut 448. In an embodiment, the fastener 414 may also extend through the base portion 444 of the lower portion.

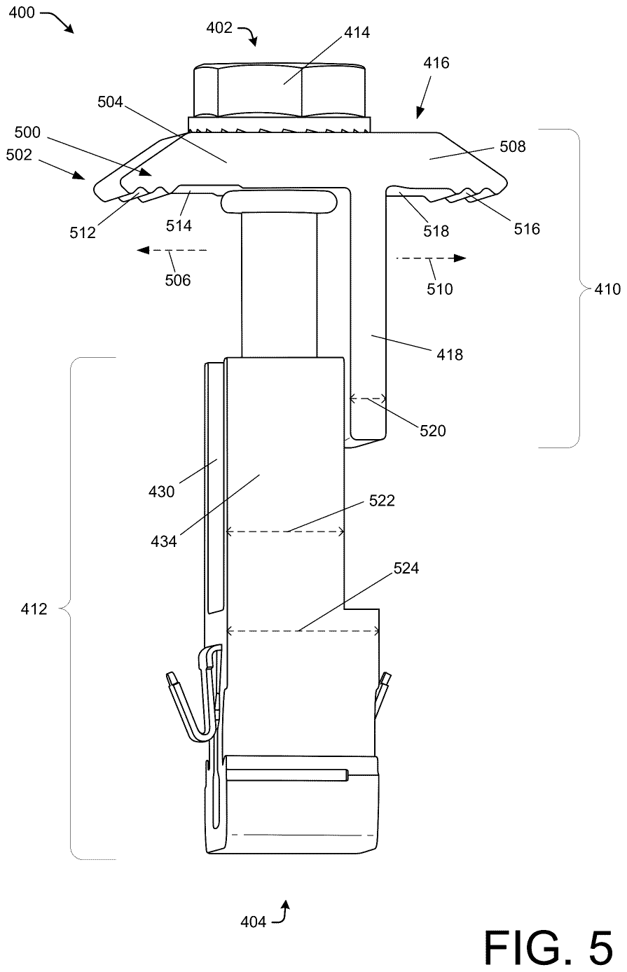

FIG. 5 illustrates a side view of the module clamp 400 of FIG. 4A. In an embodiment, the upper portion 410 may have a side 500 (e.g., first side, front side, etc.) and a side 502 (e.g., second side, back side, etc.). In an embodiment, the ledge 416 may have a portion 504 (e.g., ledge, first ledge, front ledge, etc.) extending in a direction 506 away from the wall 418 and a portion 508 (e.g., second ledge, rear ledge, etc.) in a direction 510 away from the wall 418.

The portion 504 may include one or more rows of teeth 512 protruding from the portion 504 that extend(s) from the side 500 to the side 502 on a bottom surface 514 of the portion 504. The portion 508 may include one or more rows of teeth 516 protruding from the portion 508 that extend(s) from the side 500 to the side 502 on a bottom surface 518 of the portion 504. In an embodiment, the fastener 414 may extend through the portion 504.

In an embodiment, the wall may have a width 520. The arm 430 and the arm 434 may have a width 522. In an embodiment, the bridge section 436 may have a width 524. In an embodiment the wall 418 may be configured to slidably engage along the arm 430 and the arm 434. For example, the wall 418 may be recessed within the arm 434. In an embodiment, when the wall 418 is planarly engaged against the arms 430 and the arm 434, the width of the wall 418 and the width of arm 430 and 434 may be equal to width 524 such that wall 418 and arms 430 and 434 are even at width 524.

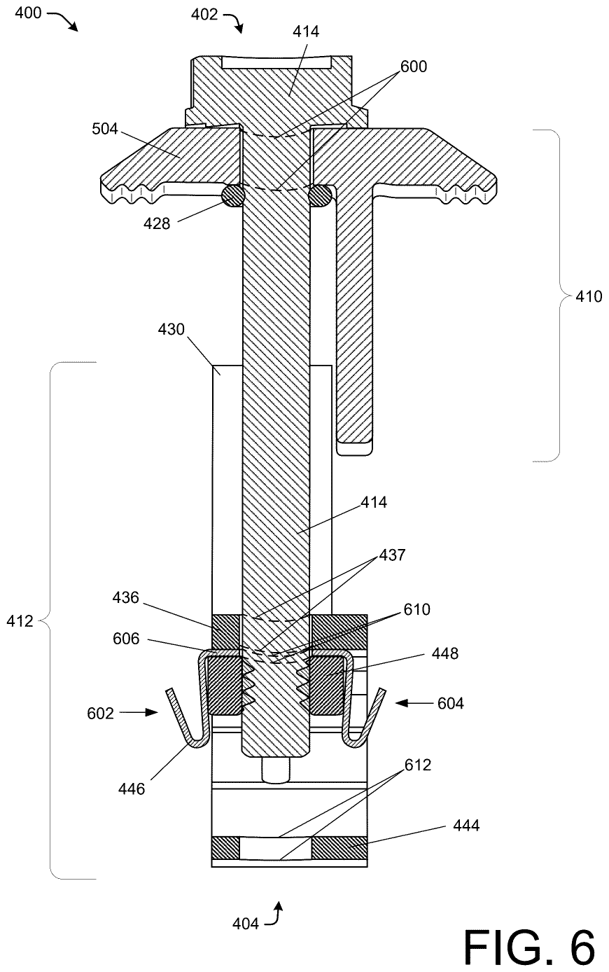

FIG. 6 illustrates a partial cutaway of a side view of the module clamp 400 of FIG. 4A. In an embodiment, the portion 504 may include an aperture 600 extending from the top end 402 of the portion 504 to the bottom end 404 of the portion 504. The aperture 600 may be sized to accommodate the fastener 414.

In an embodiment, the grounding clip 446 may include a side 602 (e.g., first side, front side, etc.), a side 604 (e.g., second side, rear side, etc.), a bridge 606. The bridge 606 of the grounding clip 446 may include an aperture 610 sized to accommodate the fastener 414. In an embodiment, the grounding clip 446. The bridge 606 may extend from the side 602 to the side 604. The side 602, the side 604, and the bridge 606 may define a cavity sized to accommodate the nut 448. When the nut 448 is disposed within the cavity defined by the side 602, the side 604, and the bridge 606, the side 602 and the side 604 may prevent the nut 448 from being able to rotate within the grounding clip 446. The aperture 610 may be located in the bridge 606 such that when the nut 448 is within the grounding clip 446, the aperture 610 is aligned with the hole of the nut 448.

In an embodiment, the base portion 444 may include an aperture 612 sized to accommodate the fastener 414. In an embodiment, when the module clamp 400 is assembled, the fastener 414 may pass through the apertures 600 and 610. In an embodiment, when the module clamp 400 is assembled, the fastener 414 may pass through the apertures 600, 610, and 612.

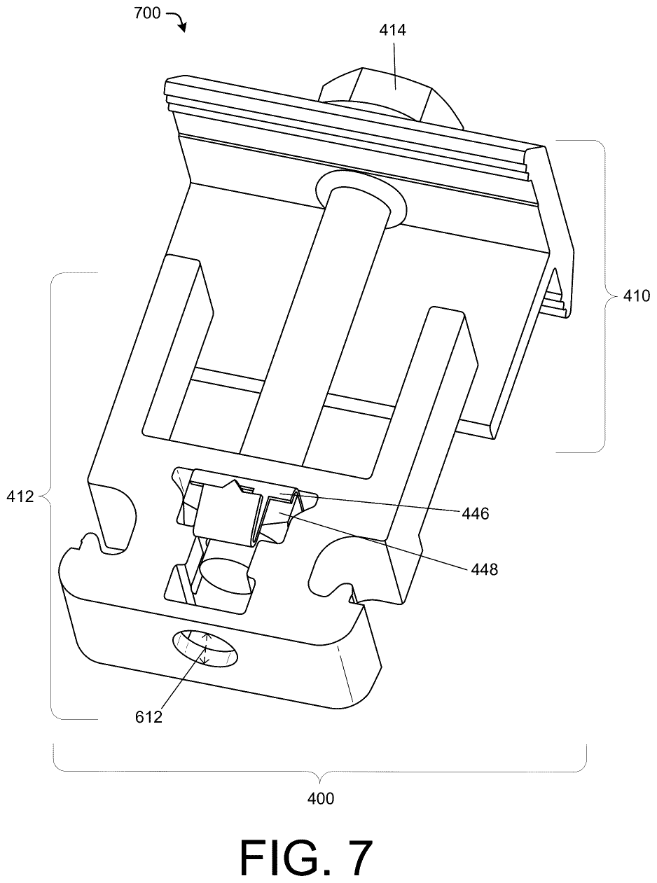

FIG. 7 illustrates a bottom-front-side view 700 of the module clamp 400 of FIG. 4A. In an embodiment, the module clamp 400 may be configured such that rotating the fastener 414 may adjust the distance between the upper portion 410 and the lower portion 412. For example, if the fastener 414 is rotated clockwise, the fastener 414 will engage with the nut 448 within the lower portion 412. In the example, as the fastener 414 continues to rotate clockwise, the upper portion 410 is pulled toward the lower portion 412.

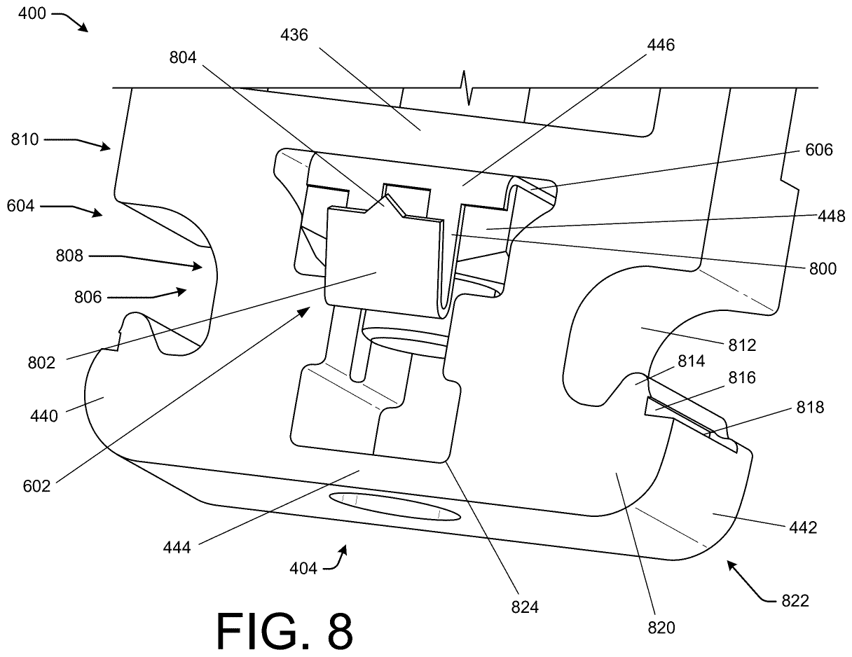

FIG. 8 illustrates a bottom-front closeup view of a portion of the module clamp 400 of FIG. 4A.

In an embodiment, the side 602 of the grounding clip 446 may include a wall 800, a grounding tab 802 and a grounding point 804. The wall 800 may extend in a direction away from the bridge 606 of the grounding clip 446. The grounding tab 802 may extend in a direction away from the wall 800 toward the top end 402 of the clamp 400. The grounding tab 802 may extend to the grounding point 804. In an embodiment, the grounding point 804 may be configured to scratch the outside surface of a solar panel module in order to facilitate electrical bonding when the clamp is installed on the solar panel module. The side 604 (not shown) may include a wall 806 (not shown), a grounding tab 808 (not shown), and a grounding point 810 (not shown). In an embodiment, the operation and appearance of side 604 and its components may be mirror-symmetrical of side 602.

In an embodiment, rail portion 442 may include a curved portion 812 that extends from the bottom end 404 of the bridge section 436 towards the bottom end 404 of the lower portion 412 to substantially form a C-shape. In an embodiment a grounding protrusion 814 may extend from the bottom end 404 of the curved portion 812. The grounding protrusion 814 may include a channel 816 and a sharp corner 818.

In an embodiment, the channel 816 may extend from a surface 820 (e.g., first surface, front surface, etc.) of the lower portion 412 toward a surface 822 (e.g., second surface, rear surface, etc.) of the lower portion 412. The channel 816 may only partially extend toward the surface 822, such that the channel 816 terminates before extending to the surface 822. Accordingly, the termination of channel 816 may cause a sharp corner 818 to be exposed.

In an embodiment, the rail portion 442 may be configured to be received by a solar panel mounting rail. It is understood that as the module clamp 400 is tightened onto a solar panel mounting rail, the rail portion 442 may be pressed against an inside surface of the mounting rail. As the rail portion 442 is pressed against the inside surface of the mounting rail, the sharp corner 818 may scratch a surface coating of the mounting rail (e.g., an anodized coating from an anodized aluminum surface). In an embodiment, the operation and appearance of rail portion 440 and its components may be mirror-symmetrical of rail portion 442.

In an embodiment, the lower portion 412 of the module clamp 400 may include a cavity 824 (e.g., void, hollow, through hole, etc.). In an embodiment, the cavity 824 may be sized and or configured to receive the grounding clip 446 and the nut 448. When the grounding clip 446 and the nut 448 are disposed within the cavity 824, the fastener 414 may extend through the aperture 437, the aperture 610, the nut 448, and the aperture 612, as required. The cavity 824 may be sized to accommodate the fastener 414 while the fastener 414 extends through the aperture 437, the aperture 610, the nut 448, and the aperture 612.

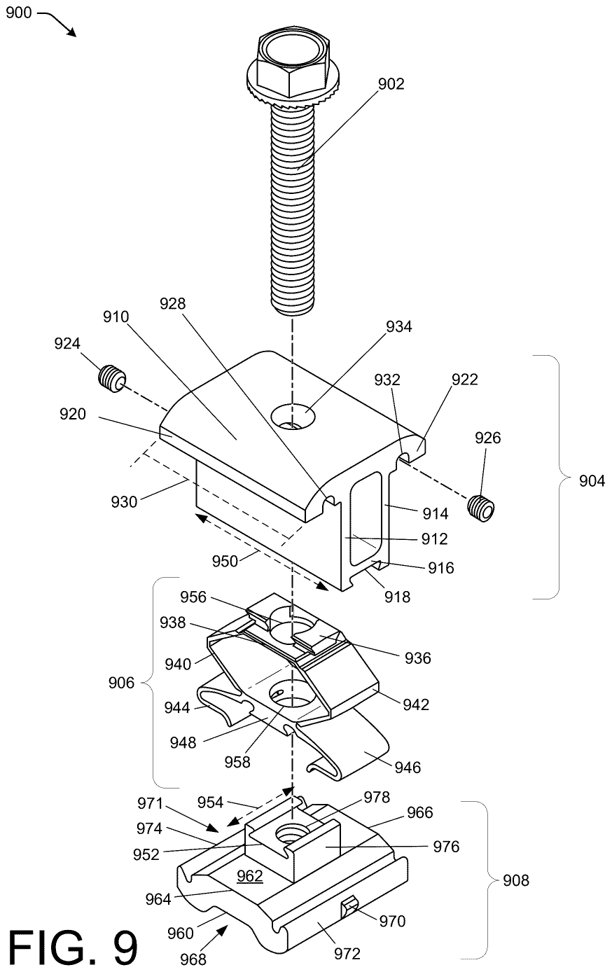

FIG. 9 illustrates an exploded front-side view of a module clamp 900. In an embodiment, the module clamp 900 may include a fastener 902, a clamp portion 904, a retainer clip 906, and a rail nut 908.

In an embodiment, the clamp portion 904 may include a ledge portion 910, a side wall 912 (e.g., first side wall, front side wall, etc.), a side wall 914 (e.g., second side wall, rear side wall, etc.), a base portion 916, a keyway 918. The ledge portion 910, the side wall 912, the side wall 914, and the base portion 916 may define a void that extends through the clamp portion 904. In an embodiment, the ledge portion 910 may include a protrusion 920 (e.g., first protrusion, front protrusion, etc.), a protrusion 922 (e.g., second protrusion, rear protrusion, etc.), a set screw 924 (e.g., first set screw, front set screw, etc.), and a set screw 926 (e.g., second set screw, rear set screw, etc.).

The protrusion 920 may include a channel 928 that extends along the length 930 of the protrusion 920. In an embodiment, the channel 928 may be configured to receive the set screw 924 such that a portion of the threads of set screw 924 extend beyond the bottom surface of the protrusion 920. In an embodiment, the set screw 924 may be rotated within the channel 928 to achieve a compression fit therein. In an embodiment, the threads of the set screw 924 may scratch, mar, or otherwise compromise the coating of the clamp portion 904 (e.g., an anodized coating, etc.).

In an embodiment, the protrusion 922 may include a threaded channel 932 that extends along the length 930 of the protrusion 922. In an embodiment, the threaded channel 932 may be configured to receive the set screw 926 such that a portion of the threads of set screw 926 extend beyond the bottom surface of the protrusion 922.

The clamp portion 904 may include an aperture 934 (e.g., edge aperture, first aperture, top aperture, etc.) that extends through the ledge portion 910. The clamp portion may include an aperture (e.g., base aperture, second aperture, bottom aperture, etc.) (not shown) extending through the base portion 916. In an embodiment, the aperture 934 and the base aperture may be sized and aligned such that the fastener 902 may extend through the clamp portion 904.

In an embodiment, the retainer clip 906 may include a keyed surface 936 (e.g., first keyed surface, top keyed surface, etc.), a bridge portion 938, an arm 940 (e.g., first arm, etc.), an arm 942 (e.g., second arm, etc.), an arm 944 (e.g., third arm, etc.), an arm 946 (e.g., fourth arm, etc.), and a keyed surface 948 (e.g., second keyed surface, bottom keyed surface, etc.). In an embodiment, the keyed surface 936 may be configured to slidably engage with the keyway 918 of the clamp portion 904 in the direction 950. In an embodiment, the keyed surface 948 may be configured to slidably engage with a keyway 952 of the rail nut 908 in a direction 954.

The retainer clip 906 may also include an aperture 956 extending through the bridge portion 938 and an aperture 958 that extends through the keyed surface 948. In an embodiment, the aperture 956 and the aperture 958 may be sized and aligned such that the fastener 902 may extend through the retainer clip 906. In an embodiment, the keyed surface 936 may be disposed within the keyway 918 such that the apertures 956 and 958 align with the aperture 934 and the base aperture to accommodate the fastener 902. The apertures 956 and 958 may be sized and oriented to allow the aperture to extend through the retainer clip 906.

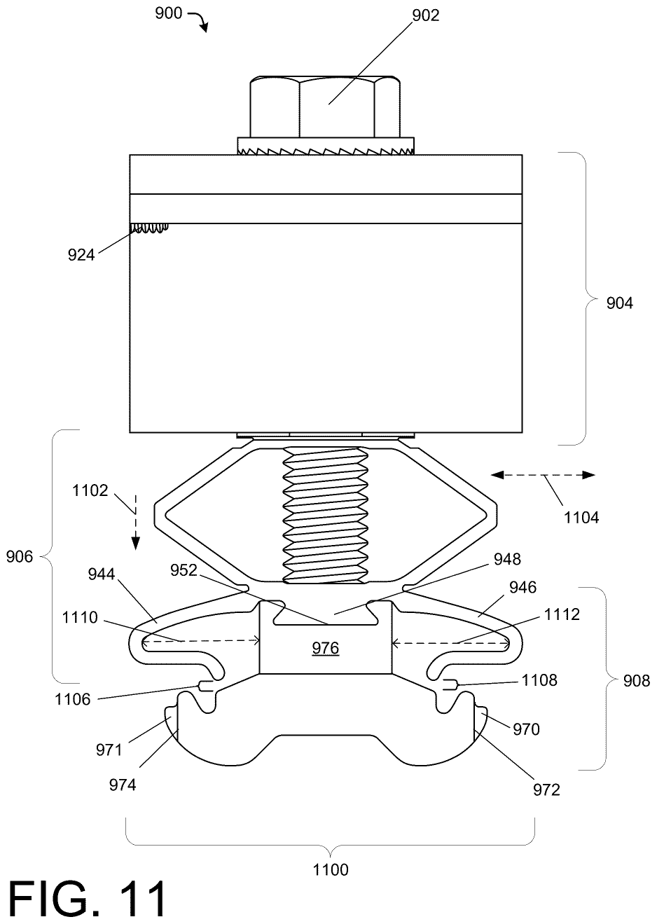

In an embodiment, the rail nut 908 may include a bottom surface 960 opposite the top surface 962 and extending between the end 964 (e.g., first end, front end, etc.) and the end 966 (e.g., second end, rear end, etc.). The bottom surface 960 may be defined by a concave shape 968 in a side profile thereof. The concave shape 968 may be configured to accommodate wire disposed through a solar panel mounting rail while the module clamp 900 is installed therein. The rail nut 908 may include one or more protrusions 970 extending from side 972 (e.g., first side, etc.) and one or more protrusions 971 (not shown in FIG. 9, see FIG. 11), extending from side 974 (e.g., second side, etc.) for puncturing, scratching, or compromising a surface coating of a solar panel mounting rail (e.g., anodized layer, paint layer, galvanizing layer, etc.) in order to allow for electrical bonding between the module clamp 900 and the solar panel mounting rail.

The top surface 962 may include a mounting protrusion 976. The mounting protrusion 976 may include the keyway 952 and a threaded aperture 978. The threaded aperture 978 may be configured to receive a threaded portion of the fastener 902. The keyway 952 may be configured to slidably engage with the keyed surface 948 of the retainer clip 906.

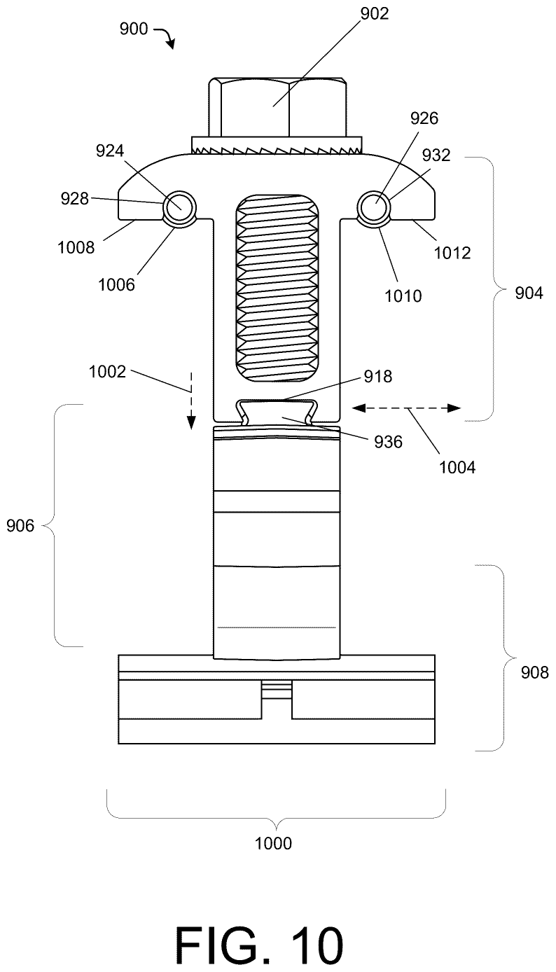

FIG. 10 illustrates a side profile view 1000 of the module clamp 900 of FIG. 9. When assembled (e.g., the keyed surface 936 is slidably engaged with the keyway 918, etc.) the shape of the keyed surface 936 and the shape of the keyway 918 may prevent the retainer clip 906 from moving in the direction 1002 or the direction 1004. When the set screw 924 is installed within the threaded channel 928, threads 1006 are exposed below bottom surface 1008 of the clamp portion 904. In an embodiment, the threads 1006 may be configured for puncturing, scratching, or compromising a surface coating of a solar panel module (e.g., anodized layer, paint layer, galvanizing layer, etc.) in order to allow for electrical bonding between the module clamp 900 and the solar panel module.

When the set screw 926 is installed within the threaded channel 932, threads 1010 are exposed below bottom surface 1012 of the clamp portion 904. In an embodiment, the threads 1010 may be configured for puncturing, scratching, or compromising a surface coating of a solar panel module (e.g., anodized layer, paint layer, galvanizing layer, etc.) in order to allow for electrical bonding between the module clamp 900 and the solar panel module.

FIG. 11 illustrates a side profile view 1100 of the module clamp 900 of FIG. 9. When module clamp 900 is assembled (e.g., the keyed surface 948 is slidably engaged with the keyway 952, etc.) the shape of the keyed surface 948 and the shape of the keyway 952 may prevent the rail nut 908 from moving in the direction 1102 or the direction 1104.

In an embodiment, when the retainer clip 906 is joined with the rail nut 908 via the keyed surface 948 and the keyway 952, the arm 944 is separated by from the rail nut 908 by gap 1106. Similarly, when the retainer clip 906 is joined with the rail nut 908 via the keyed surface 948 and the keyway 952, the arm 946 is separated by from the rail nut 908 by gap 1108. The gaps 1106 and 1108 may be configured to allow for wire and/or cable management. For example, when the module clamp 900 is installed in a solar panel mounting rail, the gap 1106 may allow electrical wire to be installed into area 1110 between the arm 944 and the mounting protrusion 976. Similarly, the gap 1108 may allow electrical wire to be installed into area 1112 between the arm 946 and the mounting protrusion 976.

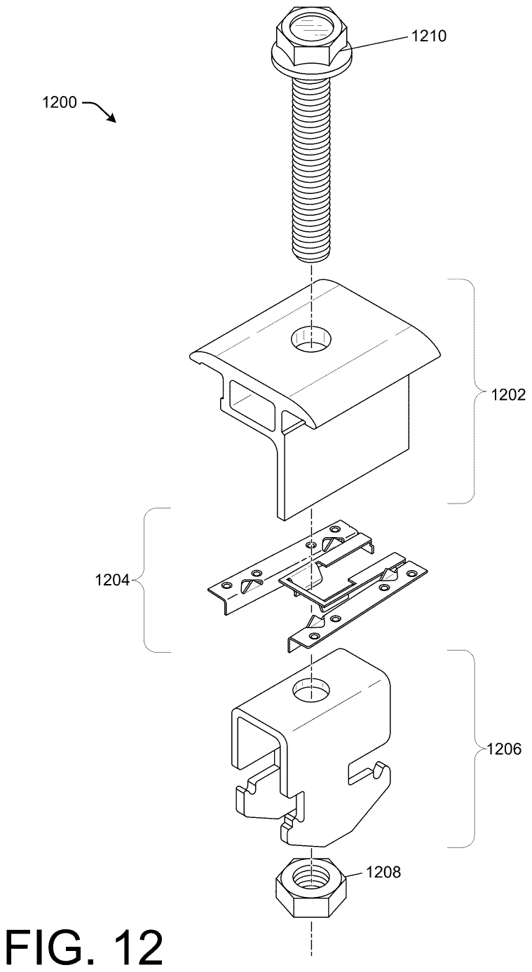

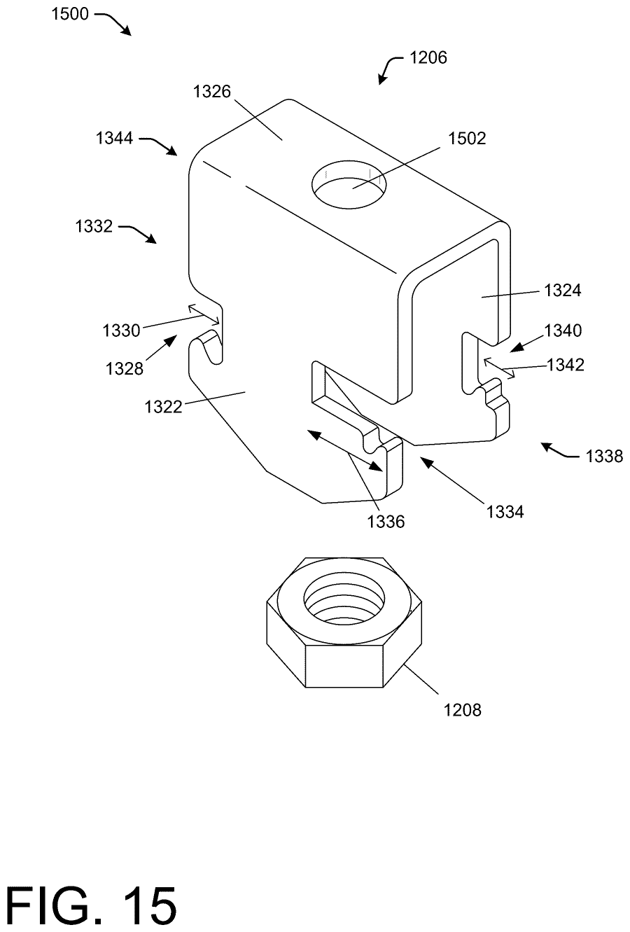

FIG. 12 illustrates an exploded front-side view of a module clamp 1200. In an embodiment, the module clamp 1200 may include an upper portion 1202 (e.g., first portion, clamping portion, top portion, etc.), a bonding clip 1204 (e.g., clip, middle portion, second portion, etc.), a rail nut 1206 (e.g., lower portion, bottom portion, third portion, etc.), a nut 1208, and a fastener 1210. In an embodiment, the rail nut 1206 may include a threaded aperture (not shown). In an embodiment, the rail nut 1206 may be attached to the nut 1208 to form a rail nut assembly (not shown in FIG. 12, see FIG. 15).

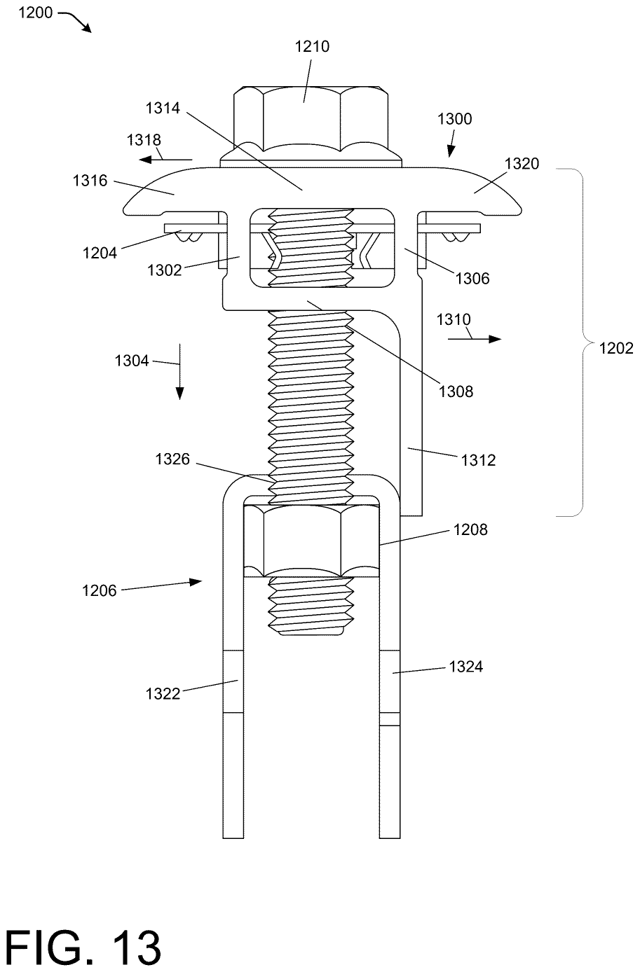

FIG. 13 illustrates a side profile view of an assembled module clamp 1200 of FIG. 12. In an embodiment, the fastener 1210 may extend through the upper portion 1202, the bonding clip 1204, the rail nut 1206, and engage with the nut 1208. In an embodiment, the nut 1208 may be disposed within the rail nut 1206 such that the nut 1208 is fixed in position and does not rotate within the rail nut 1206. In an embodiment, rotation of the fastener 1210, when the module clamp 1200 is assembled, may adjust the relative distance between the upper portion 1202 and the rail nut 1206.

In an embodiment, the upper portion 1202 may include a top wall 1300 (e.g., first wall, cap, top section, etc.), a first sidewall 1302 extending away from the top wall 1300 in a first direction 1304, a second sidewall 1306 extending away from the top wall 1300 in the first direction 1304, a bottom wall 1308 extending from the first sidewall 1302 to the second sidewall 1306 in a second direction 1310, and a third wall 1312 extending from the bottom wall 1308 in the first direction 1304. In an embodiment, the top wall 1300 may include a middle section 1314, a first section 1316 (e.g. first clamping section, first ledge etc.) extending away from the middle section 1314 in a third direction 1318, and a second section 1320 extending from the middle section 1314 in the second direction 1310.

In an embodiment, the rail nut 1206 may include a first sidewall 1322 extending in the first direction 1304, a second sidewall 1324 extending in the first direction 1304, and a bridge portion 1326 extending from a top end of the first sidewall 1322 to the top end of the second sidewall 1324 in the second direction 1310.

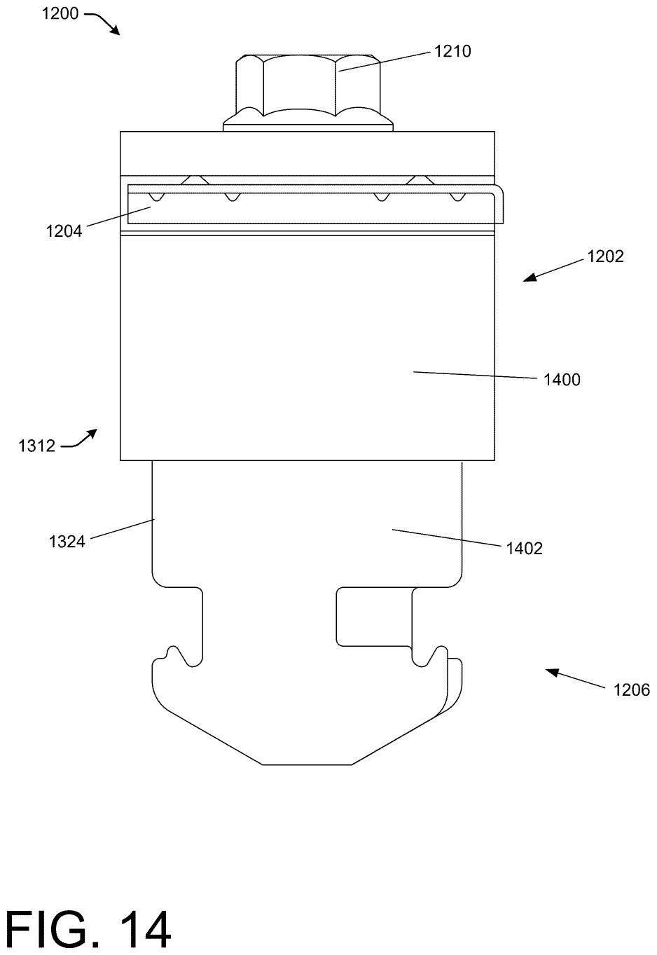

FIG. 14 illustrates a side profile view of the module clamp 1200 of FIG. 12. In an embodiment, the first sidewall 1302 (not shown in FIG. 14, see FIG. 13) may be configured to engage with a side surface of a solar panel. In an embodiment, the third wall 1312 may include an outside surface 1400 (e.g., outer surface, first surface, etc.). In an embodiment, the outside surface 1400 may face away from the solar panel module, when the module clamp 1200 is installed. In an embodiment, the second sidewall 1324 of rail nut 1206 may include an outside surface 1402. In an embodiment, the third wall 1312 may be configured to engage with the outside surface 1402 of the second sidewall 1324 of the rail nut 1206.

FIG. 15 illustrates an isometric view a rail nut assembly 1500. In an embodiment, the rail nut assembly 1500 may include the rail nut 1206 and the nut 1208. In an embodiment, the bridge portion 1326 of the rail nut 1206 may include an aperture 1502 extending through the bridge portion 1326. In an embodiment, the first sidewall 1322 of rail nut 1206 may include a first slot 1328 extending inwardly a first distance 1330 from a first side end 1332 of the rail nut 1206. The first sidewall 1322 of rail nut 1206 may also include a second slot 1334 extending inwardly a second distance 1336 from a second side end 1338 of the rail nut 1206. The first slot 1328 and the second slot 1334 may be colinear (i.e., extend inwardly toward each other on a same line).

In an embodiment, the second sidewall 1324 likewise may include a first slot 1340 extending inwardly a third distance 1342 from the second side end 1338 of the rail nut 1206. The second sidewall 1324 of rail nut 1206 may also include a second slot 1344 (not shown) extending inwardly a fourth distance (not shown) from the first side end 1332 of the rail nut 1206. The first slot 1340 and the second slot 1344 (not shown) may be colinear (i.e., extend inwardly toward each other on a same line).

In an embodiment, the first distance 1330 may be the same or similar to the third distance 1342. In an embodiment, the second distance 1336 may be the same or similar to the fourth distance (not shown). In an embodiment, the second slot 1334 of the first sidewall 1322 and the first slot 1340 of the second sidewall 1324 may extend parallel to one another with respect to the second side end 1338.

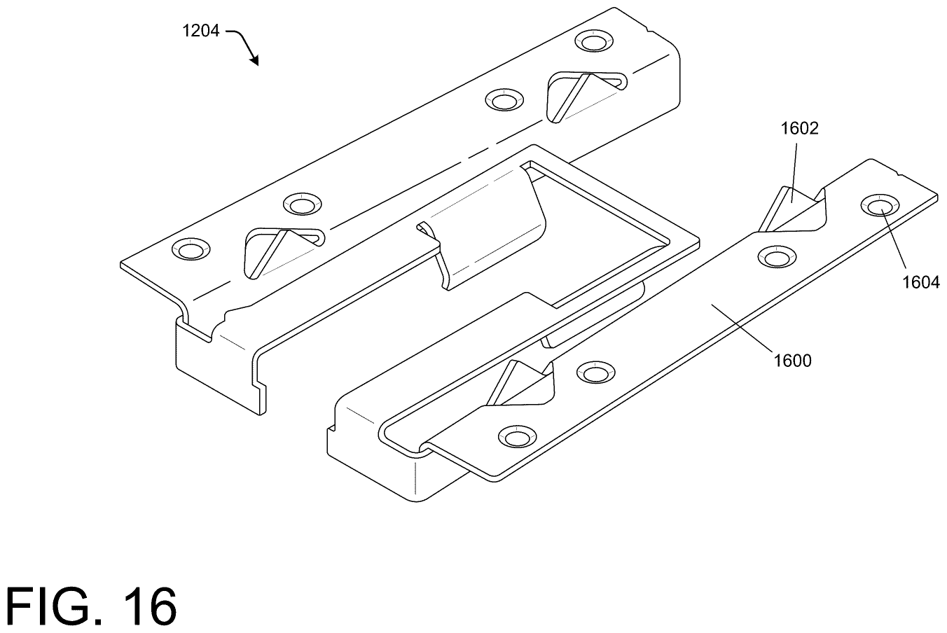

FIG. 16 illustrates an isometric view of a bonding clip 1204. In an embodiment, the bonding clip 1204 may include a top surface 1600 (e.g., first surface, upper surface, etc.). In an embodiment, the bonding clip 1204 may include a protrusion 1602 (e.g., first protrusion, first bonding pin, etc.) extending away from the top surface 1600. In an embodiment, the protrusion 1602 may be configured for puncturing, scratching, or compromising a surface coating of the upper portion 1202 of the module clamp 1200 (e.g., anodized layer, paint layer, galvanizing layer, etc.) in order to allow for electrical bonding between the bonding clip 1204 and the upper portion 1202 of the module clamp 1200. In an embodiment, the bonding clip 1204 may include a protrusion 1604 (e.g., second protrusion, second bonding pin, etc.) extending away from the protrusion 1602. In an embodiment, the protrusion 1604 may be configured for puncturing, scratching, or compromising a surface coating of a solar panel module (e.g., anodized layer, paint layer, galvanizing layer, etc.) in order to allow for electrical bonding between the bonding clip 1204 and the solar panel module.

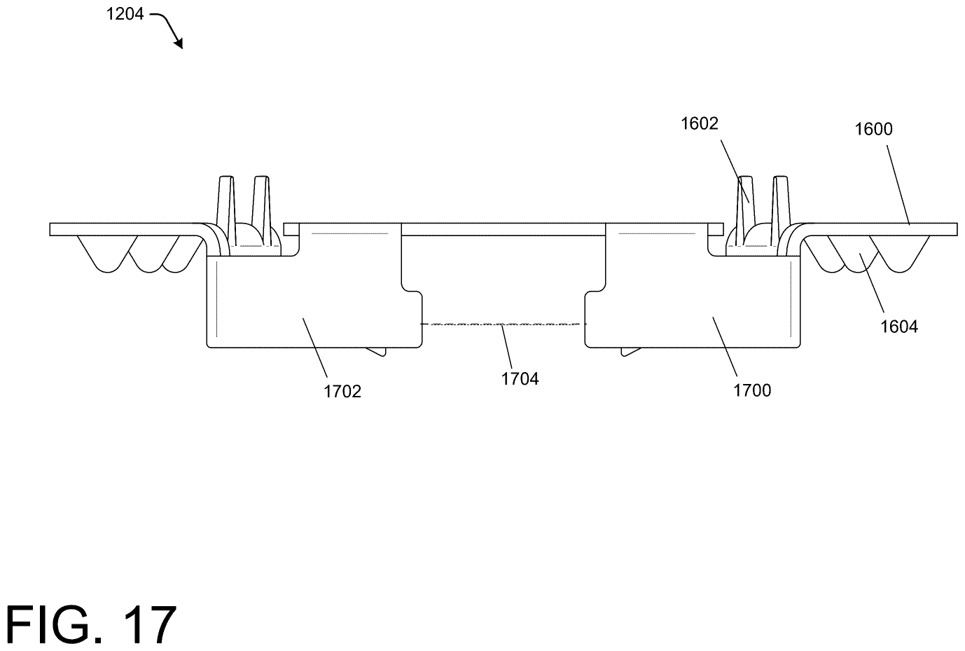

FIG. 17 illustrates a front view of a bonding clip 1204. In an embodiment, the bonding clip 1204 may include a first front wall 1700 and a second front wall 1702 separated by a gap 1704.

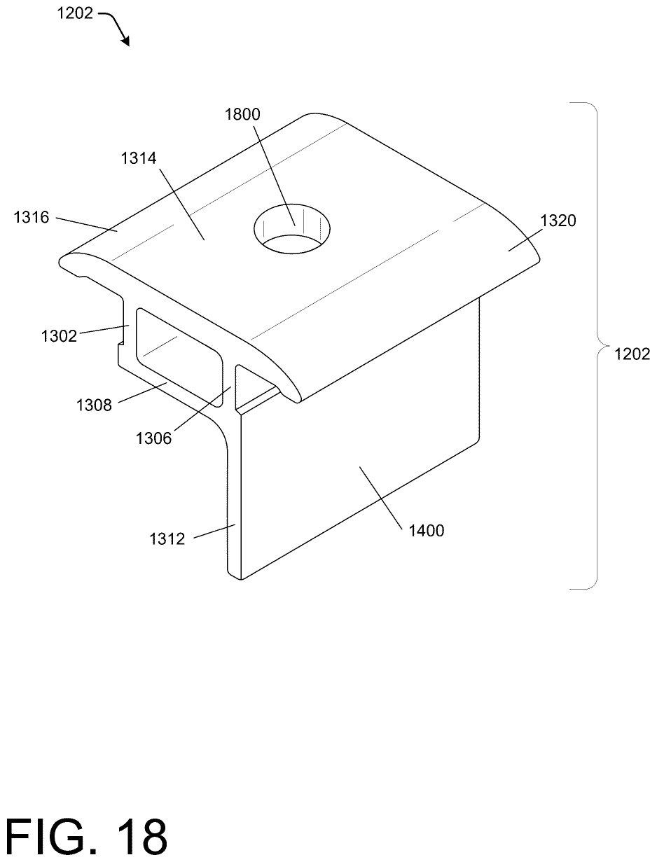

FIG. 18 illustrates an isometric view of the upper portion 1202 of the module clamp 1200 of FIG. 12. In an embodiment, the middle section 1314 of the top wall 1300 may include an aperture 1800 that extends through the middle section 1314. The aperture 1800 is sized to accommodate the fastener 1210 therethrough.

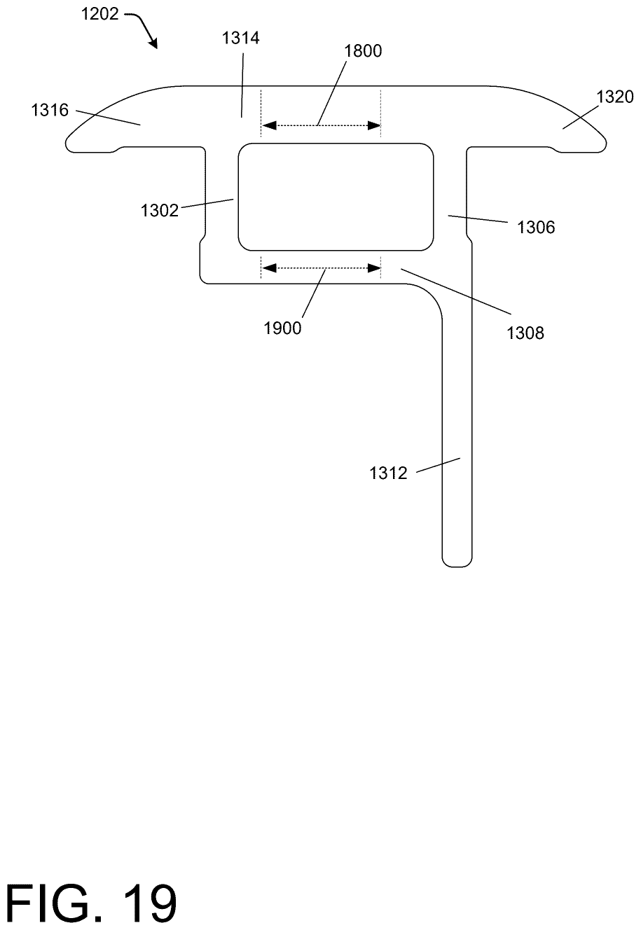

FIG. 19 illustrates a side profile view of an upper portion 1202 of the module clamp 1200 of FIG. 12. In an embodiment, the bottom wall 1308 of the upper portion 1202 may include an aperture 1900 (e.g., second aperture, lower aperture, etc.) extending through the bottom wall 1308. In an embodiment, the aperture 1800 extending through the middle section 1314 may be aligned with the aperture 1900 extending through the bottom wall 1308 such that the fastener 1210 may extend through the aperture 1800 and the aperture 1900.

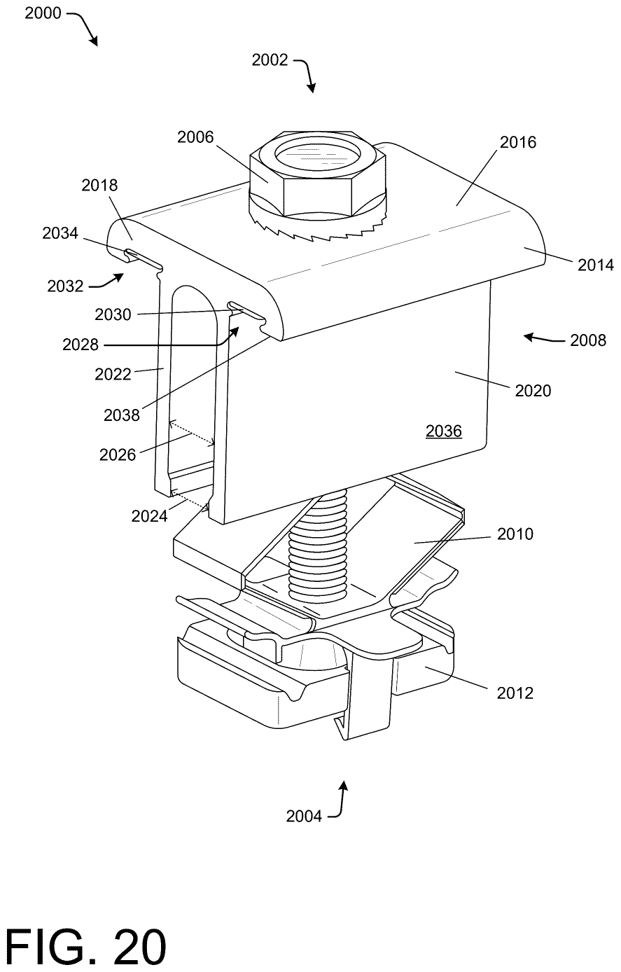

FIG. 20 illustrates a side-front view of a module clamp 2000. In an embodiment, the module clamp 2000 may include a top end 2002 (e.g., upper end etc.), a bottom end 2004 (e.g., lower eld, etc.), a fastener 2006, a clamp portion 2008, a retainer clip 2010, and a rail nut 2012. In an embodiment, the fastener 2006 may penetrate the clamp portion 2008, the retainer clip 2010, and the rail nut 2012.

In an embodiment, the clamp portion 2008 may include a ledge 2014 (e.g., first ledge, front ledge, etc.), a top surface 2016 to engage with the fastener 2006, a ledge 2018 (e.g., second ledge, rear ledge, etc.), a side wall 2020 (e.g., first side wall, front side wall, etc.), a side wall 2022 (e.g., second side wall, rear side wall, etc.), a keyway 2024 (e.g., first keyway, gap, first gap, lower gap, narrow opening, etc.) at the bottom end 2004 of the clamp portion 2008, and a keyway 2026 (e.g., second keyway, gap, second gap, upper gap, wider opening, etc.) adjacent to the first keyway 2024.

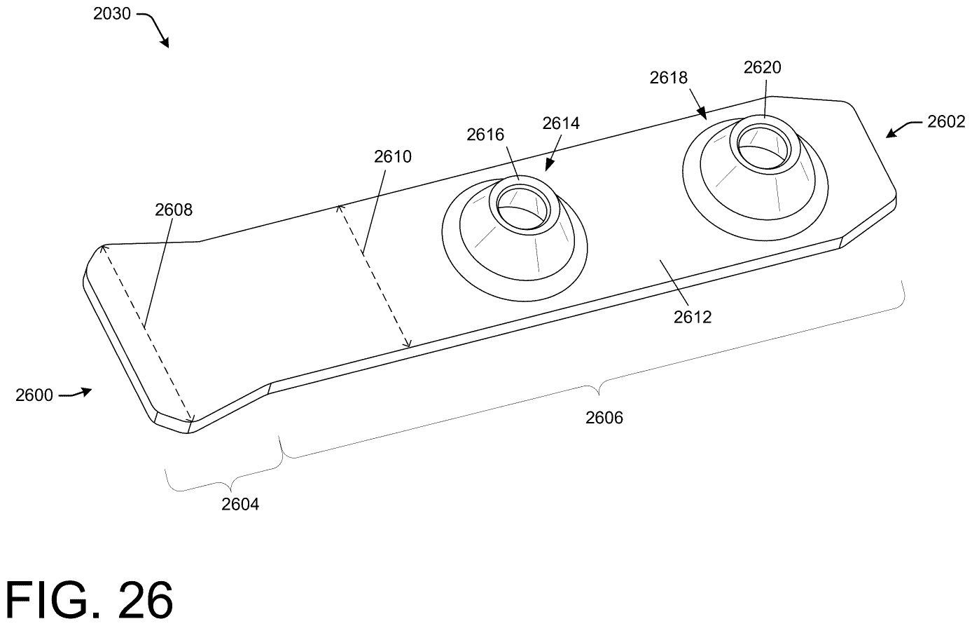

In an embodiment, the first ledge 2014 may include a slot 2028 (e.g., first slot, front grounding tab slot, front slot, etc.) configured to receive a grounding tab 2030 (See FIG. 26). In an embodiment, the second ledge 2018 may include a slot 2032 (e.g., second slot, rear grounding tab slot, rear slot, etc.) configured to receive a grounding tab 2034 (e.g. second grounding tab, etc.). In an embodiment, the second grounding tab 2034 may be identical to the first grounding tab 2030, but the second grounding tab 2034 may be sized and/or shaped differently than the first grounding tab 2030.

In an embodiment, the first side wall 2020 may include a surface 2036 (e.g., side surface, first side surface, first surface, front surface, first mounting surface, etc.) configured to engage with a side surface of a photovoltaic module (not shown). In an embodiment, the first ledge 2014 may include a surface 2038 (e.g., second surface, top surface, upper clamping surface, etc.) configured to engage with a top surface of a photovoltaic module (not shown).

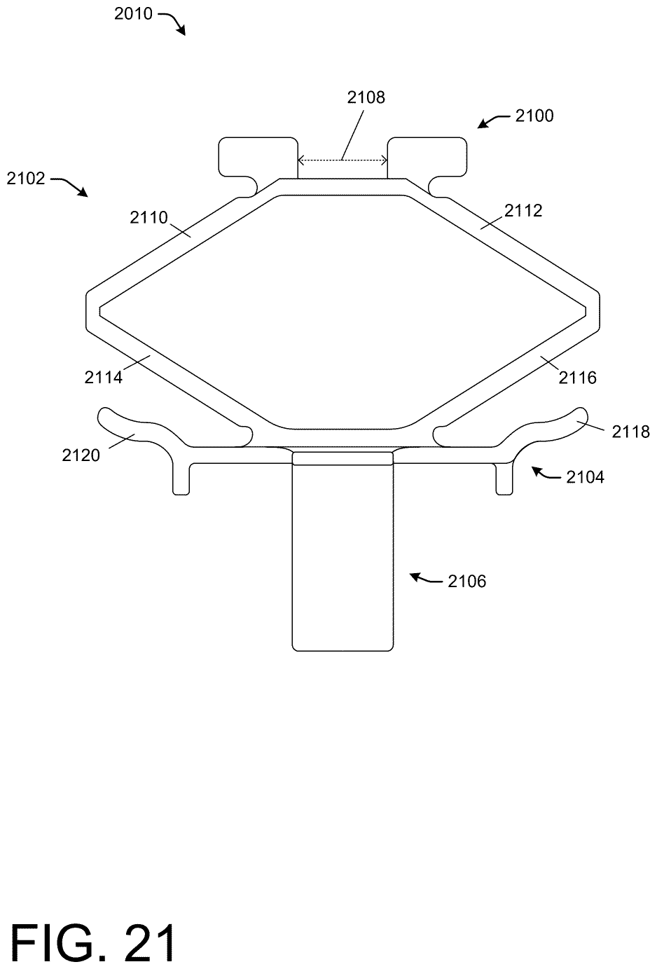

FIG. 21 illustrates a side view of the retainer clip 2010 of FIG. 20. In an embodiment, the retainer clip 2010 may include a keyed portion 2100 (e.g., upper portion, top portion, etc.), a spring portion 2102 (e.g., biasing portion, spring section, etc.), a rail portion 2104 (e.g., rail section, email engagement section, etc.), and rail nut clip 2106 (e.g., bottom portion, clip portion, clip section, etc.).

In an embodiment, the keyed portion 2100 may include an aperture 2108 the extending therethrough. In an embodiment, the keyed portion 2100 may be configured to slidably engage with the first keyway 2024 and the second keyway 2026. In an embodiment, the spring portion 2102 may include a first arm 2110 (e.g., section, segment, etc.), a second arm 2112 (e.g., section, segment, etc.), a third arm 2114 (e.g., section, segment, etc.), and a fourth arm 2116.

In an embodiment, the rail portion 2104 may include a first arm 2118 and a second arm 2120. The first arm 2118 and the second arm 2120 may be configured to slidably engage with an inside surface of a mounting rail (not shown). In an embodiment, the rail nut clip 2106 may be configured to engage with the rail nut 2012.

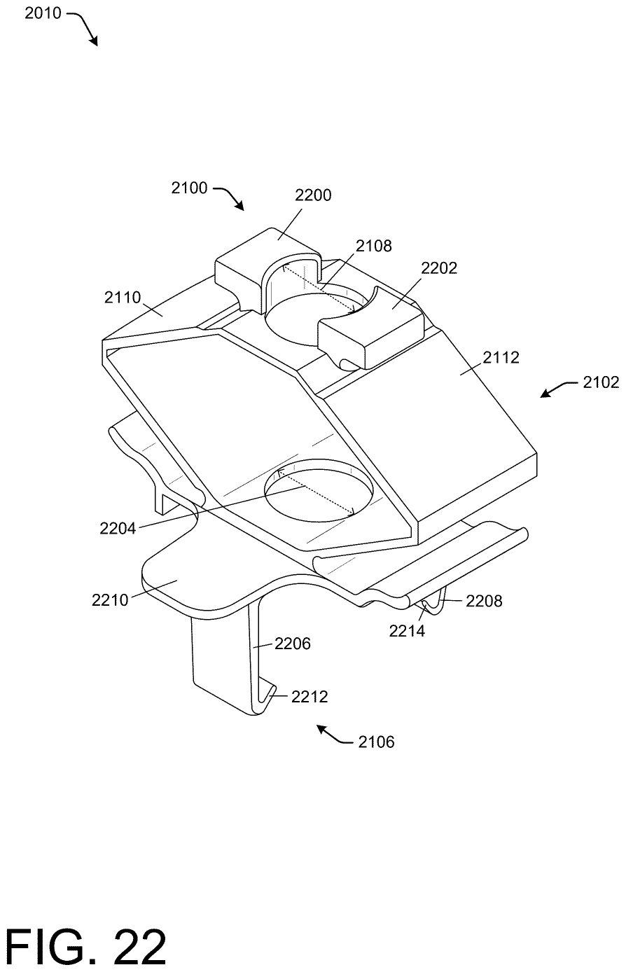

FIG. 22 illustrates an isometric view of a retainer clip 2010. In an embodiment, the keyed portion 2100 may include a first tab 2200 separated from a second tab 2202 by the aperture 2108. The retainer clip may include an aperture 2204 (e.g., second aperture, lower aperture, etc.) that extends through the spring portion 2102. The aperture 2108 and the aperture 2204 may be aligned such that the fastener 2006 may pass through both apertures.

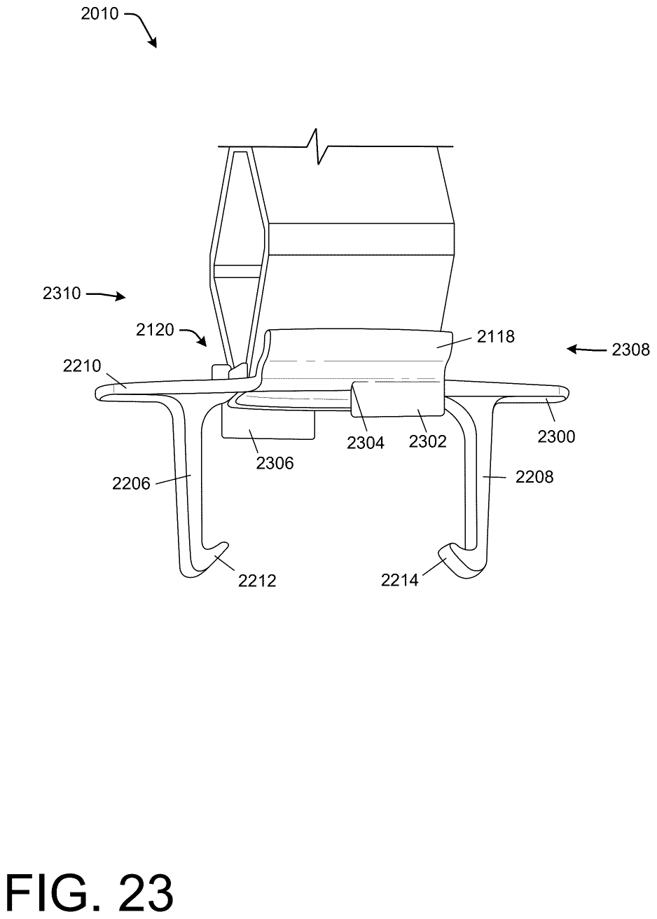

In an embodiment, the rail nut clip 2106 may include a first locking arm 2206, a second locking arm 2208, a first release tab 2210, and a second release tab (not shown in FIG. 22, see FIG. 23). In an embodiment, the first locking arm 2206 may be biased toward the second locking arm 2208 and the second locking arm 2208 may be biased toward the first locking arm 2206. The first locking arm 2206 may extend from the first release tab 2210. In an embodiment, the first release tab 2210 may be configured such that as the first release tab 2210 is raised, the first locking arm 2206 is pulled in a direction away from the second locking arm 2208.

In an embodiment, the first locking arm 2206 may include a hook 2212 (e.g., first hook, tab, etc.) at an end of the first locking arm 2206. In an embodiment, the hook 2212 may be configured to engage with a bottom surface of the rail nut 2012. In an embodiment, the second locking arm 2208 may include a hook 2214 (e.g., second hook, tab, etc.) at an end of the second locking arm 2208. In an embodiment, the hook 2214 may be configured to engage with a bottom surface of the rail nut 2012.

FIG. 23 illustrates a side-front view of a portion of a retainer clip 2010. The retainer clip 2010 may include a second release tab 2300. In an embodiment, the second locking arm 2208 may extend from the second release tab 2300. In an embodiment, the second release tab 2300 may be configured such that as the second release tab 2300 is raised, the second locking arm 2208 is pulled in a direction away from the first locking arm 2206.

In an embodiment, the first arm 2118 may include a first positioning tab 2302 and a first positioning edge 2304. In an embodiment, the second arm 2120 may include a second positioning tab 2306 and a second positioning edge (not shown). In an embodiment, the first positioning tab 2302 may extend from a first end 2308 of the retainer clip 2010 (e.g., first side, etc.) toward a second end 2310 (e.g., second side, etc.) of the retainer clip 2010. The first positioning tab 2302 may only partially extend toward the second end 2310, such that the first positioning tab 2302 terminates before extending to the second end 2310. Accordingly, the termination of first positioning tab 2302 may cause the formation of the first positioning edge 2304. In an embodiment, the first positioning edge 2304 and the second positioning edge (not shown) may prevent over rotation of the module clamp 2000 relative to the mounting rail and may ensure that the module clamp 2000 remains oriented perpendicular to the mounting rail.

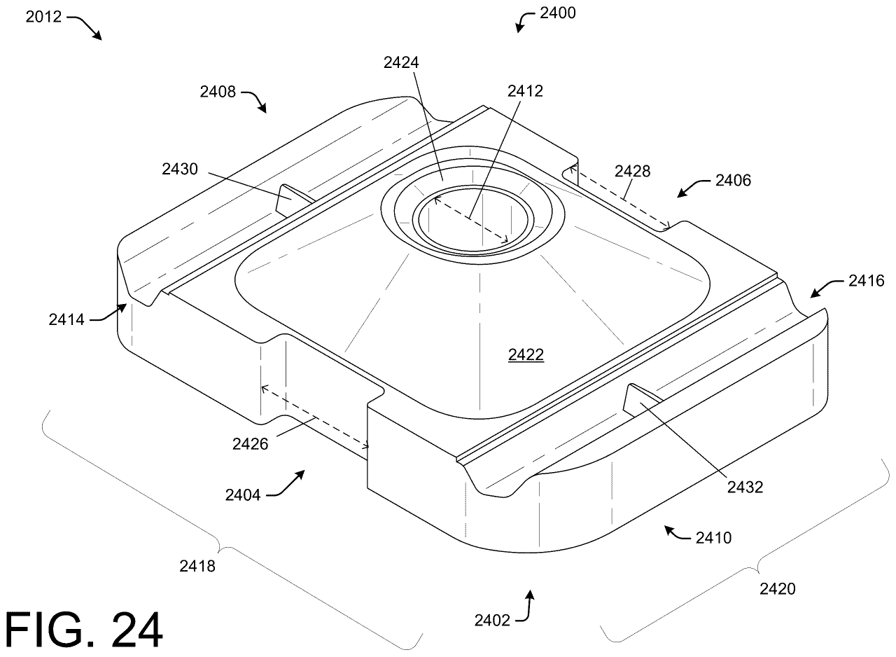

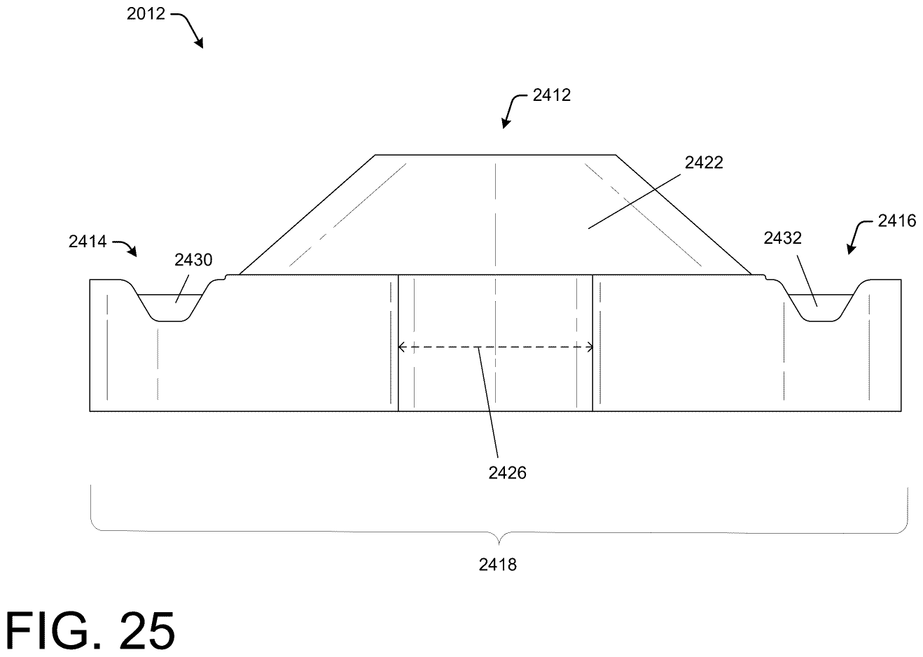

FIGS. 24 and 25 illustrate multiple views of a rail nut 2012.

FIG. 24 illustrates an isometric view of a rail nut 2012. In an embodiment, the rail nut 2012 may include a top 2400 (e.g., top side, etc.), a bottom 2402 (e.g., bottom side, etc.), a front 2404 (e.g., front side, front face, front end, etc.), a rear 2406 (e.g., rear side, rear face, rear end, etc.) a first side 2408 (e.g., left side, etc.), and a second side 2410 (e.g., right side, etc.). In an embodiment, the rail nut 2012 may include an aperture 2412 that extends from the top 2400 of the rail nut 2012 to the bottom 2402 of the rail nut 2012, a first groove 2414 extending from the front 2404 to the rear 2406 along the first side 2408, and a second groove 2416 extending from the front 2404 to the rear 2406 along the second side 2410. In an embodiment, the front 2404 and the rear 2406 may have a length 2418 (e.g. first length, width, first width, etc.). In an embodiment, the first side 2408 and the second side 2410 may have a length 2420 (e.g., second length, second width, etc.). In an embodiment, the second length 2420 may be shorter than the first length 2418.

In an embodiment, the rail nut 2012 may include a raised surface 2422. In an embodiment, the raised surface 2422 may include one or more sloped sides extending away from the top 2400 of the rail nut 2012, and towards a centered apex (e.g., top, tip, etc.) at the aperture 2412 (e.g., tapered). The raised surface 2422 may have any desired shape (e.g., cone-shaped, pyramid-shaped, etc.), as required. In an embodiment, the shape of the raised surface 2422 may allow for the centered apex to be received by the aperture 2204.

In an embodiment, the aperture 2412 may be configured to engage with the fastener 2006 (e.g., the aperture 2412 is threaded). The sloped sides of the raised surface 2422 may allow for the rail nut to self-level as it is drawn into the retainer clip 2010. For example, when the module clamp 2000 is assembled, the fastener 2006 extends through the clamp portion 2008 via, the retainer clip 2010, and is engaged with the rail nut 2012. As the as the fastener 2006 rotates within the rail nut 2012, the rail nut 2012 is raised or lowered, relative to the retainer clip 2010. In an embodiment, as the fastener 2006 is rotated clockwise, the rail nut 2012 is drawn into the retainer clip 2010. As the rail nut 2012 is drawn into the retainer clip 2010, the sloped side(s) of the raised surface 2422 allows the rail nut 2012 to be level. In an embodiment, the raised surface 2422 may include a sloped surface 2424. The sloped surface 2424 may extend from the apex of the raised surface 2422 to the aperture 2412.

In an embodiment, the front 2404 of the rail nut 2012 may include a slot 2426 (e.g., front slot, first slot, etc.). In an embodiment, the rear 2406 of the rail nut 2012 may include a slot 2428 (e.g., rear slot, second slot, etc.). In an embodiment, the front slot 2426 may be configured to receive the first locking arm 2206. In an embodiment, the rear slot 2428 may be configured to receive the second locking arm 2208. In an embodiment, the front slot 2426 is identically sized and shaped as the rear slot 2428.

In an embodiment, the first groove 2414 may be configured to slidably engage with a first wall of a mounting rail (not shown). In an embodiment, the second groove 2416 may be configured to slidably engage with a second wall of a mounting rail (not shown).

In an embodiment, the first groove 2414 may include a grounding point 2430 (e.g., first grounding point, first point, etc.). In an embodiment, the second groove 2416 may include a grounding point 2432 (e.g., second grounding point, second point, etc.). In an embodiment, the first grounding point 2430 and the second grounding point 2432 may scratch, mar, or otherwise compromise the coating of a mounting rail (e.g., scratch an anodized coating, remove a paint layer, etc.) to improve grounding (e.g. electrical grounding, electrical bonding, etc.).

FIG. 25 illustrates a side profile view of the rail nut 2012 of FIG. 24.

FIG. 26 illustrates a bottom-side view of a grounding tab 2030. In an embodiment the grounding tab 2030 may include a first end 2600, a second end 2602, a first section 2604 (e.g., tail section, rear section, etc.) and a second section 2606 (e.g., main section, body section, flat section, etc.). In an embodiment, the first section 2604 may have a first width 2608. In an embodiment the second section 2606 may have a second width 2610 that is narrower than the first width 2608.

In an embodiment, the second section 2606 may include a surface 2612 (e.g., first surface, top surface, etc.). In an embodiment, the grounding tab may include a first grounding point 2614 extending from the surface 2612. The first grounding point 2614 may include an edge 2616 (e.g. first edge, first sharp edge, etc.). In an embodiment, the grounding tab may include a second grounding point 2618 extending from the surface 2612. The second grounding point 2618 may include a second edge 2620 (e.g. second edge, second sharp edge, etc.). In an embodiment, the first grounding point 2614 and the second grounding point 2618 may scratch, mar, or otherwise compromise the coating of a solar panel module (e.g., scratch an anodized coating, remove a paint layer, etc.) to improve grounding (e.g. electrical grounding, electrical bonding, etc.).

In an embodiment, the first width 2608 may be such that the first section 2604 forms a compression fit with the sides of the first slot 2028 and/or the second slot 2032 when installed. In an embodiment, the compression fit between the first section 2604 of the grounding tab and the sides of the first slot 2028 and/or the second slot 2032 may scratch, mar, or otherwise compromise the coating of the sides of the first slot 2028 and/or the second slot 2032 (e.g., scratch an anodized coating, remove a paint layer, etc.) to improve grounding (e.g. electrical grounding, electrical bonding, etc.).

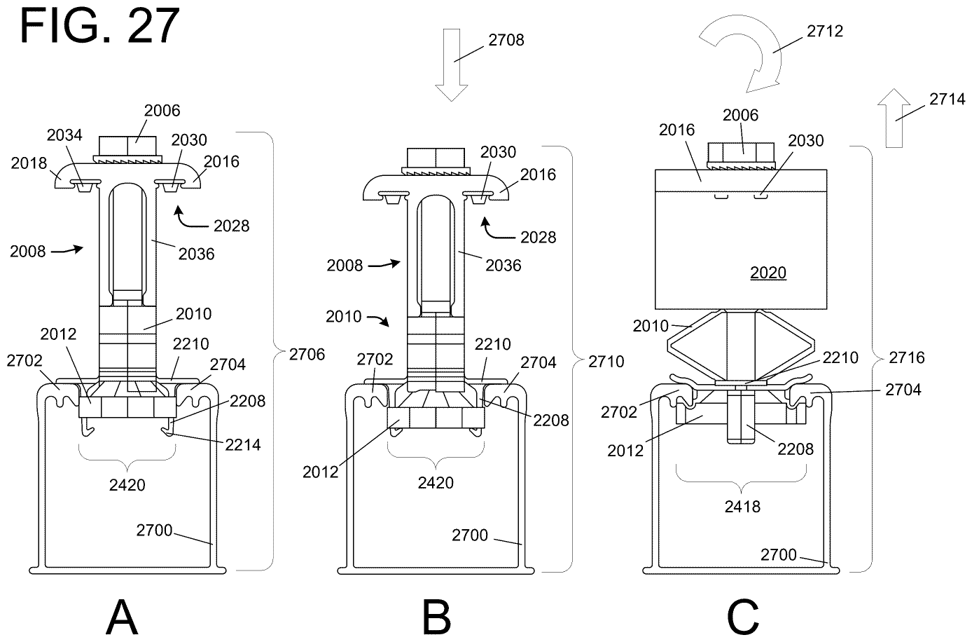

FIG. 27 illustrates stages (A-C) of installation of a module clamp 2000 into a mounting rail 2700. In an embodiment, the mounting rail 2700 may include a first arm 2702 (e.g., first arm, left arm, front arm, etc.) and an arm 2704 (e.g., second arm, right arm, rear arm, etc.)

In an embodiment, stage A may illustrate the module clamp 2000 being placed into a mounting rail 2700 such that the second length 2420 of rail nut 2012 extends between the first arm 2702 and the second arm 2704 of the mounting rail 2700. In an embodiment, the distance between the first arm 2702 and the second arm 2704 may be large enough accommodate the second length 2420, but not large enough to accommodate the first length 2418 of the rail nut 2012. At stage A, the rail nut 2012 may be disposed between the first arm 2702 of the mounting rail 2700 and the second arm 2704 such that the first arm 2702 and the second arm 2704 may prevent the rotation of the rail nut 2012.

In an embodiment, the module clamp 2000 within the mounting rail 2700 at stage A may have a length 2706.

In an embodiment, stage B may illustrate the module clamp 2000 being pressed down in a direction 2708 (e.g., first direction, downward, toward the mounting rail, etc.) after being placed into a mounting rail 2700. In an embodiment, when the module clamp 2000 is inserted into the mounting rail 2700, the first release tab 2210 and the second release tab 2300 of the retainer clip 2010 may rest on a top surface of the first arm 2702 and a top surface of the second arm 2704 of the mounting rail 2700. In an embodiment, as the module clamp 2000 is depressed into the mounting rail 2700, the spring portion 2102 (not shown in FIG. 27, see FIG. 21) of the retainer clip 2010 may be compressed such that the clamp portion 2008 of the module clamp 2000 may be drawn towards the mounting rail 2700.

In an embodiment, the fastener 2006 may couple the clamp portion 2008 to the rail nut 2012. Accordingly, as the spring portion 2102 of the retainer clip 2010 compresses, the fastener 2006, the clamp portion 2008, and the rail nut 2012 may also move in the direction 2708.

At stage B, the rail nut 2012 may be disposed below the first arm 2702 of the mounting rail 2700 and the second arm 2704 such that the first arm 2702 and the second arm 2704 may not prevent the rotation of the rail nut 2012. In an embodiment, the module clamp 2000 within the mounting rail 2700 at stage B may have a length 2710. In an embodiment, length 2710 may be shorter than length 2706.

In an embodiment, stage C may illustrate the module clamp 2000 being rotated in a direction 2712 (e.g., second direction, clockwise, counterclockwise, etc.). In an embodiment, when the spring portion 2102 of the retainer clip 2010 is compressed such that the rail nut 2012 is below the first arm 2702 and the second arm 2704 of the mounting rail 2700, the module clamp 2000 (e.g., the fastener 2006, the clamp portion 2008, the retainer clip 2010, and the rail nut 2012) may be rotated in the direction 2712. In an embodiment, the rail nut 2012 may be oriented such that the first length 2418 may extend from the first arm 2702 to the second arm 2704. At stage C, the first groove 2414 of the rail nut 2012 may be aligned with a portion of the first arm 2702 and the second groove 2416 of the rail nut 2012 may be aligned with a portion of the second arm 2704.

At stage C, when the module clamp 2000 is no longer being depressed in the direction 2708, the spring portion 2102 of the retainer clip 2010 may force the clamp portion 2008 in a direction 2714 (e.g., third direction, upward, etc.) opposite the direction 2708. As the spring portion 2102 of the retainer clip 2010 forces the clamp portion 2008 in the upward direction 2714, the clamp portion 2008 may force the fastener 2006 in the upward direction 2714. As the fastener 2006 is forced in the upward direction 2714, the fastener 2006, being coupled to the rail nut 2012, may force the rail nut 2012 to engage with the bottom surfaces of the first arm 2702 and the second arm 2704 of the mounting rail 2700. At stage C, a portion of the first arm 2702 may be disposed within the first groove 2414 of the rail nut 2012 and a portion of the second arm 2704 may be disposed within the second groove 2416 of the rail nut 2012.

In an embodiment, the module clamp 2000 within the mounting rail 2700 at stage C may have a length 2716. In an embodiment, the length 2716 may be longer than the length 2710 and shorter than the length 2706.

In an embodiment, when the module clamp 2000 is oriented similarly to the orientation of the module clamp 2000 relative to the mounting rail 2700 at stage C, the module clamp may be depressed in the direction 2708 such that the rail nut 2012 no longer contacts the mounting rail 2700. When the rail nut 2012 no longer contacts the mounting rail 2700, the module clamp 2000 may be moved (e.g., slid, etc.) within the mounting rail 2700 in a direction parallel to the mounting rail 2700.

### CONCLUSION

Although several embodiments have been described in language specific to structural features and/or methodological acts, it is to be understood that the claims are not necessarily limited to the specific features or acts described. Rather, the specific features and acts are disclosed as illustrative forms of implementing the claimed subject matter.

What is claimed is:

1. A clamp assembly comprising:
a module clamp including:
a lateral edge support portion that extends in a first direction,
a first ledge that extends in a second direction transverse to the first direction at a first end of the lateral edge support portion, and
a second ledge that extends in a third direction opposite the second direction at the first end of the lateral edge support portion;
a fastener having a first end opposite a second end, the first end configured to interface with a top surface of the second ledge; and
a clamp base attached to the second end of the fastener, the clamp base including:
a frame,
a nut configured to engage with the second end of the fastener, and
a grounding clip partially surrounding the nut.

2. The clamp assembly of claim 1, wherein the frame includes:
a frame base configured to receive the nut and the grounding clip;
a first arm extending from the frame base in a fourth direction opposite the first direction, the first arm including:
a first side configured to engage the lateral edge support portion, and
a second side opposite the first side; and
a second arm extending from the frame base in the fourth direction, the second arm including:
a first side configured to engage the lateral edge support portion, and
a second side opposite the first side.

3. The clamp assembly of claim 2, wherein the lateral edge support portion includes:
a first side configured to engage the second side of the first arm of the frame and the second arm of the frame; and
a second side opposite the first side.

4. The clamp assembly of claim 3, wherein the lateral edge support portion is recessed into the first arm and the second arm such that the second side of the lateral edge support portion is even with frame base.

5. The clamp assembly of claim 2, wherein the frame base includes:
a first side;
a second side opposite the first side;
a first protrusion extending from the first side, the first protrusion configured to engage with a first inner groove of a mounting rail, the first protrusion including a sharp corner; and
a second protrusion extending from the second side, the second protrusion configured to engage with a second inner groove of a mounting rail, the first protrusion including a sharp corner.

6. The clamp assembly of claim 2, wherein:
the nut is a square nut; and
the grounding clip includes:
a first grounding tab having a point, and
a second grounding tab having a point.

7. The clamp assembly of claim 2, wherein the first ledge includes an aperture configured to accommodate the fastener.

8. A solar panel module mounting system including:
a clamp assembly including:
a bonding clamp, including;
a base configured to engage with a mounting rail, the base including:
a first side configured to engage with the bonding clamp, and
a second side opposite the first side; and
a fastener having a first end configured to engage with the bonding clamp and a second end configured to engage with the base.

9. The solar panel module mounting system of claim 8, wherein the base includes:
a frame having a cavity accommodating a nut and a grounding clip therein, the frame including:
a first arm at a first end of the frame extending in a first direction, the first arm including:
a first side configured to engage a surface of the bonding clamp, and
a second side opposite the first side; and
a second arm at a second end of the frame, opposite the first end of the frame, the second arm extending in the first direction, the second arm including:
a first side configured to engage the surface of the bonding clamp, and
a second side opposite the first side.

10. The solar panel module mounting system of claim 9, wherein the grounding clip includes:
a first tab extending away from the first side of the first arm in a second direction transverse to the first direction, the first tab including a first point, and
a second tab extending away from the second side of the first arm in a third direction transverse to the first direction, the second tab including a second point.

11. The solar panel module mounting system of claim 8, wherein the base includes:
a first protrusion extending from a first end of the base, the first protrusion configured to engage with a first inner groove of a mounting rail; and
a second protrusion extending from a second end of the base, the second protrusion configured to engage with a second inner groove of the mounting rail.

12. The solar panel module mounting system of claim 11, wherein:
the first protrusion includes a sharp corner configured to compromise a surface coating of the first inner groove of the mounting rail; and
the second protrusion includes a sharp corner configured to compromise a surface coating of the second inner groove of the mounting rail.

13. The solar panel module mounting system of claim 8, wherein the bonding clamp includes:
a first wall extending in a first direction including:
a first row of teeth protruding from a surface of the first wall at a first end, and
a second row of teeth protruding from the surface of the first wall at a second end; and
a second wall protruding from the surface of the first wall in a second direction transverse to the first direction, the second wall including:
a first surface configured to engage with the second side of the base, and
a second surface opposite the first surface.

14. A clamp assembly, comprising:
a bonding clamp including:
a wall extending in a first direction;
a first ledge extending from a first end of the wall in a second direction transverse to the first direction; and
a second ledge extending from the first end of the wall in a third direction opposite the second direction;
a fastener having a first end opposite a second end, the first end configured to interface with a top surface of the second ledge; and
a clamp base attached to the second end of the fastener.

15. The clamp assembly of claim 14 wherein:
the first ledge includes:
a first side,
a second side opposite the first side, a first surface extending from the first side to the second side, and
a row of teeth protruding from the first surface in a fourth direction away from the first ledge,
the second ledge includes:
a first side, and
a second side opposite the first side, a first surface extending from the first side to the second side, and
a row of teeth protruding from the first surface in the fourth direction away from the second ledge.

16. The clamp assembly of claim 14, the clamp base including:
a nut configured to engage with the second end of the fastener;
a grounding clip configured to partially surround the nut;
a frame base configured to receive the nut and the grounding clip;
a first arm extending from the frame base in a fourth direction opposite the first direction, the first arm including:
a first side configured to engage a lateral edge of a first solar panel module, and
a second side configured to engage the wall; and
a second arm extending from the frame base in the fourth direction, the second arm including:
a first side configured to engage a lateral edge of the first solar panel module, and
a second side configured to engage the wall.

17. The clamp assembly of claim 16, wherein the wall includes:
a first side configured to engage the second side of the first arm of the frame base and the second arm of the frame base; and
a second side configured to engage a lateral edge of a second solar panel module.

18. The clamp assembly of claim 16, wherein the frame base includes:
a first side;
a second side opposite the first side;
a first protrusion extending from the first side, the first protrusion configured to engage with a first inner groove of a mounting rail, the first protrusion including a sharp corner; and
a second protrusion extending from the second side, the second protrusion configured to engage with a second inner groove of a mounting rail, the first protrusion including a sharp corner.

19. The clamp assembly of claim 16, wherein the wall is recessed into the first arm and the second arm such that the second side of the wall even with the frame base.

20. The clamp assembly of claim 16 wherein the clamp base includes a cavity configured to receive:
the fastener,
the nut, and
the grounding clip.
